(19) United States
(12) Patent Application Publication
(10) Pub. No.: US 2025/0048033 A1
(43) Pub. Date: Feb. 6, 2025

(54) APPARATUS

(71) Applicant: LG Display Co., Ltd., Seoul (KR)

(72) Inventor: Kyungyeol RYU, Paju-si (KR)

(21) Appl. No.: 18/778,290

(22) Filed: Jul. 19, 2024

(30) Foreign Application Priority Data
Jul. 31, 2023 (KR) 10-2023-0100049

(51) Int. Cl. H04R 7/10; H04R 17/00

(52) U.S. Cl. CPC H04R 7/10; H04R 17/00; H04R 2307/025; H04R 2307/027

(57) ABSTRACT

An apparatus includes a vibration member, and a vibration apparatus configured to vibrate the vibration member. The vibration member includes an inner member and an outer member surrounding the inner member.

### CROSS-REFERENCE TO RELATED APPLICATION

This application claims priority to Korean Patent Application No. 10-2023-0100049 filed in the Republic of Korea on Jul. 31, 2023, the entirety of which is hereby expressly incorporated by reference into the present application.

### BACKGROUND

### Technical Field

The present disclosure relates to an apparatus, and more particularly, to an apparatus for outputting a sound.

### Description of the Related Art

Recently, the demands for slimmer and thinner electronic devices are increasing. In speakers applied to electronic devices, piezoelectric devices capable of being implemented with a thin thickness are attracting much attention instead of voice coils, based on the demands for slimmer and thinner devices.

### BRIEF SUMMARY

A speaker with a piezoelectric device or a vibration apparatus may generate (or output) sound by vibrating a vibration plate according to the vibration of piezoelectric device. The sound quality and/or sound pressure characteristics of the sound generated (or outputted) according to the vibration of vibration plate may be changed by the material of vibration plate.

The inventors of the present disclosure have recognized these limitations, and have conducted various studies and experiments to improve or optimize the sound quality characteristics and/or sound pressure characteristics of the sound generated (or output) depending on the material of the diaphragm (or vibration member) in the device or vibrating device.

One or more aspects of the present disclosure are directed to providing an apparatus which may enhance a sound characteristic and/or a sound pressure level characteristic of a sound.

One or more aspects of the present disclosure are directed to providing an apparatus in which a flatness characteristic of a sound pressure level is enhanced.

One or more aspects of the present disclosure are directed to providing an apparatus which may reduce a dip phenomenon and a peak phenomenon of a sound pressure level.

One or more aspects of the present disclosure are directed to providing an apparatus which may prevent or reduce a crack from occurring in a vibration apparatus by preventing or reducing a bending phenomenon of a vibration member and may prevent or reduce a corrosion from occurring on a surface of the vibration member under the high temperature and humid environment.

One or more aspects of the present disclosure are directed to providing an apparatus which may have uniform sound pressure characteristics by optimizing an area ratio of a vibration member and a vibration apparatus.

Additional features, advantages, and aspects of the present disclosure are set forth in part in the present disclosure and will also be apparent from the present disclosure or may be learned by practice of the inventive concepts provided herein. Other features, advantages, and aspects of the present disclosure may be realized and attained by the structure particularly pointed out in the present disclosure, or derivable therefrom, and claims hereof as well as the appended drawings.

To achieve these and other advantages and aspects of the present disclosure, as embodied and broadly described herein, in one or more aspects, an apparatus comprises a vibration member, and a vibration apparatus configured to vibrate the vibration member. The vibration member includes an inner member and an outer member surrounding the inner member.

In one or more aspects, an apparatus comprise a vibration plate, a piezoelectric layer disposed on the vibration plate, and a signal supply line electrically connected between the piezoelectric layer and the vibration plate, the piezoelectric layer configured to vibrate the vibration plate via a signal provided by the signal supply line. The vibration plate may include an inner member and an outer member surrounding the inner member.

An apparatus according to one or more aspects of the present disclosure may improve sound quality characteristics and/or sound pressure characteristics of sound and improve flatness characteristics of sound pressure.

An apparatus according to one or more aspects of the present disclosure may reduce dip and peak portions in sound.

An apparatus according to one or more aspects of the present disclosure may prevent or reduce a crack from occurring in a vibration apparatus by preventing or reducing a bending phenomenon of a vibration member and can prevent or reduce a corrosion from occurring on a surface of the vibration member under the high temperature and humid environment.

An apparatus according to one or more aspects of the present disclosure may have uniform sound pressure characteristics by optimizing an area ratio of a vibration member and a vibration apparatus.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims.

Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure, and incorporated in and constitute a part of this disclosure, illustrate aspects and aspects of the disclosure and together with the description serve to explain principles of the disclosure.

FIG. 1 is a perspective view illustrating an apparatus according to an aspect of the present disclosure.

FIG. 2 is a cross-sectional view taken along line I-I′ of FIG. 1 according to an aspect of the present disclosure.

FIG. 3 illustrates a vibration member according to an aspect of the present disclosure.

FIG. 4 illustrates a vibration apparatus according to an aspect of the present disclosure.

FIG. 5 is a cross-sectional view taken along line II-II′ of FIG. 4 according to an aspect of the present disclosure.

FIG. 6 is a cross-sectional view taken along line II-II′ of FIG. 4 according to an aspect of the present disclosure.

FIG. 7 illustrates a vibration layer according to another aspect of the present disclosure.

FIG. 8 illustrates a vibration layer according to another aspect of the present disclosure.

FIG. 9 illustrates a vibration apparatus according to another aspect of the present disclosure.

FIG. 10 illustrates a density of an inner member according to an experimental example.

FIG. 11 illustrates a modulus of an inner member according to an experimental example.

FIG. 12 illustrates sound output characteristics of an apparatus according to an experimental example.

FIG. 13 illustrates sound output characteristics of an apparatus according to an experimental example.

FIG. 14 illustrates sound output characteristics of an apparatus according to an aspect of the present disclosure.

FIG. 15 illustrates sound output characteristics of an apparatus according to an experimental example and an aspect of the present disclosure.

FIG. 16 illustrates sound output characteristics of an apparatus according to an experimental example and an aspect of the present disclosure.

FIG. 17 illustrates sound output characteristics of an apparatus according to an experimental example.

FIG. 18A illustrates a cross section of a vibration member according to an aspect of the present disclosure.

FIG. 18B illustrates an EDS analysis result of a vibration member according to an aspect of the present disclosure.

FIG. 19 is a cross-sectional view taken along line I-I′ of FIG. 1 according to another aspect of the present disclosure.

FIG. 20 illustrates sound output characteristics of the apparatus illustrated in FIG. 19 according to another aspect of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to aspects of the present disclosure, examples of which may be illustrated in the accompanying drawings. In the following description, when a detailed description of well-known methods, functions, structures or configurations may unnecessarily obscure aspects of the present disclosure, a detailed description of such known functions or configurations may have been omitted or may be briefly provided for brevity. Further, repetitive descriptions may be omitted or may be briefly provided for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

Where the term “comprise,” “have,” “include,” “contain,” “constitute,” “made of,” “formed of,” “composed of,” or the like is used with respect to one or more elements (e.g., layers, films, regions, components, sections, members, parts, regions, areas, portions, steps, operations, and/or the like), one or more other elements may be added unless a term such as “only” or the like, is used. The terms used in the present disclosure are merely used to describe example aspects, and are not intended to limit the scope of the present disclosure. The terms of a singular form may include plural forms unless the context clearly indicates otherwise.

The word “exemplary” is used to mean serving as an example or illustration, unless otherwise specified. Aspects are example aspects. “Aspects,” “examples,” “aspects,” and the like should not be construed as preferred or advantageous over other implementations. An aspect, an example, an example aspect, an aspect, or the like may refer to one or more aspects, one or more examples, one or more example aspects, one or more aspects, or the like, unless stated otherwise.

Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more other parts may be located between the two parts unless a more limiting term, such as “immediate(ly),” “direct(ly),” or “close(ly),” is used. For example, where a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, may be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, may include all directions of “above” and “below.” Likewise, an exemplary term “above” or “on” may include both directions of “above” and “below.”

In describing a temporal relationship, when the temporal order is described as, for example, “after,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

It is understood that, although the terms “first,” “second,”” “A,” “B”, “(a),” “(b),” or the like may be used herein to describe various elements (e.g., layers, films, regions, components, sections, members, parts, regions, areas, portions, steps, operations, and/or the like), these elements should not be limited by these terms, for example, to any particular order, sequence, precedence, or number of elements. These terms are used only to distinguish one element from another. For example, a first element could be termed a second element, and, similarly, a second element could be termed a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The phrase that an element (e.g., layer, film, region, component, section, or the like) is “provided,” “disposed,” “connected,” “coupled,” or the like in, on, with or to another element may be understood, for example, as that at least a portion of the element is provided, disposed, connected, coupled, or the like in, on, with or to at least a portion of another element, or that the entirety of the element is provided, disposed, connected, coupled, or the like in, on, with or to another element. The phrase that an element (e.g., layer, film, region, component, section, or the like) “contacts,” “overlaps,” or the like with another element may be understood, for example, as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other. Such terms may mean a wider range of lines or directions within which the components of the present disclosure can operate functionally. For example, the terms “first direction,” “second direction,” and the like, such as a direction parallel or perpendicular to “x-axis,” “y-axis,” or “z-axis,” should not be interpreted only based on a geometrical relationship in which the respective directions are parallel or perpendicular to each other, and may be meant as directions having wider directivities within the range within which the components of the present disclosure may operate functionally.

The term “at least one” should be understood as including any and all combinations of one or more of the associated listed items. For example, each of the phrases of “at least one of a first item, a second item, or a third item” and “at least one of a first item, a second item, and a third item” may represent (i) a combination of items provided by one or more of the first item, the second item, and the third item or (ii) only one of the first item, the second item, and the third item.

The expression of a first element, a second elements, “and/or” a third element should be understood to encompass one of the first, second, and third elements, as well as any and all combinations of the first, second and third elements. By way of example, A, B and/or C encompass only A; only B; only C; any of A, B, and C (e.g., A, B, or C); or some combination of A, B, and C (e.g., A and B; A and C; or B and C); and all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element (e.g., layer, film, region, component, sections, or the like) is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as different from one another. In another example, an expression “different from one another” may be understood as different from each other. In one or more examples, the number of elements involved in the foregoing expression may be two. In one or more examples, the number of elements involved in the foregoing expression can be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Features of various aspects of the present disclosure may be partially or entirely coupled to or combined with each other, may be technically associated with each other, and may be operated, linked, or driven together in various ways. Aspects of the present disclosure may be implemented or carried out independently of each other, or may be implemented or carried out together in a co-dependent or related relationship. In one or more aspects, the components of each apparatus according to various aspects of the present disclosure may be operatively coupled and configured.

Unless otherwise defined, the terms (including technical and scientific terms) used herein have the same meaning as commonly understood by one of ordinary skill in the art to which example aspects belong. It should be further understood that terms, such as those defined in commonly used dictionaries, should be interpreted as having a meaning that is, for example, consistent with their meaning in the context of the relevant art and should not be interpreted in an idealized or overly formal sense, unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example aspects.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

“X-axis direction,” “Y-axis direction,” and “Z-axis direction,” should not be construed by a geometric relation only of a mutual vertical relation and may have broader directionality within the range that elements of the present disclosure may act functionally.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness. Thus, aspects of the present disclosure are not limited to a scale, dimension, size, or thickness illustrated in the drawings.

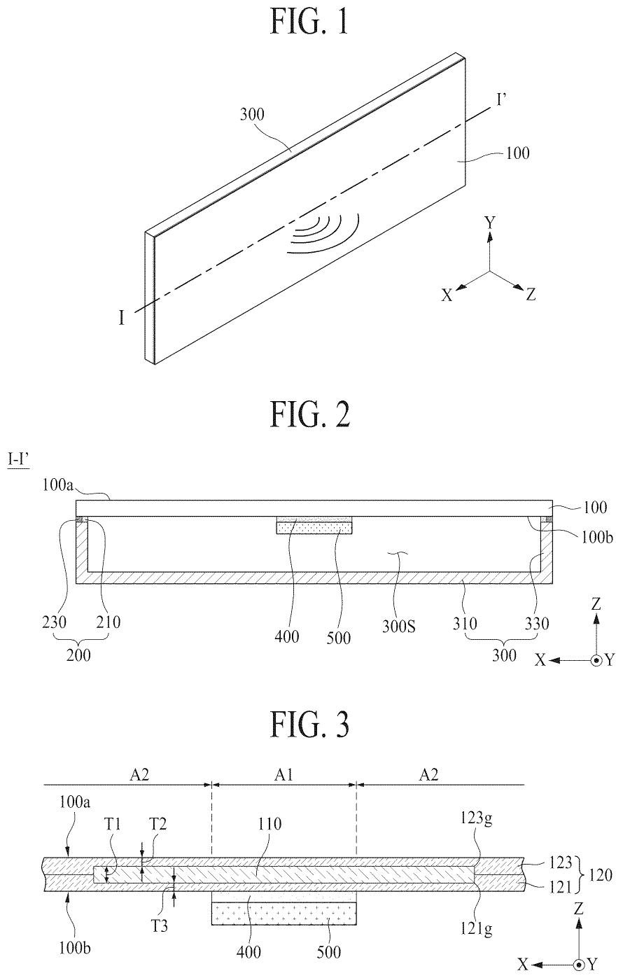

FIG. 1 is a perspective view illustrating an apparatus according to an aspect of the present disclosure. FIG. 2 is a cross-sectional view taken along line I-I′ of FIG. 1 according to an aspect of the present disclosure.

Referring to FIGS. 1 and 2, an apparatus according to an aspect of the present disclosure may be implemented as or realized as at least one of a display apparatus, an electronic apparatus, a sound apparatus, a sound output apparatus, a vibration apparatus, a vibration generating apparatus, a sound bar, a sound system, a sound apparatus for electronic apparatuses, a sound apparatus for displays, a sound apparatus for vehicular apparatuses (or transporting apparatuses), or a sound bar for vehicular apparatuses (or transporting apparatuses), or the like. For example, the vehicular apparatus (or transporting apparatus) may include a vehicle, a train, a ship, a mobile device, or an aircraft, but aspects of the present disclosure are not limited thereto. Further, the apparatus according to an aspect of the present disclosure may be implemented as or realized as an analog signage or a digital signage, or the like such as an advertising signboard, a poster, or a noticeboard, or the like.

The apparatus according to an aspect of the present disclosure may include a vibration member 100 and a vibration apparatus 500.

The vibration member 100 may generate a vibration or may output a sound (or a sound wave), based on a displacement (or driving) of the vibration apparatus 500. The vibration member 100 may be a vibration object, a signage panel, a passive vibration plate, a front member, a vibration panel, a sound panel, a passive vibration panel, a sound output plate, a sound vibration plate, or the like, but aspects of the present disclosure are not limited thereto.

The vibration member 100 according to an aspect of the present disclosure may include a polygonal shape including a rectangular shape or a square shape, but aspects of the present disclosure are not limited thereto. The vibration member 100 may include a widthwise length parallel to a first direction X and a lengthwise length parallel to a second direction Y. For example, with respect to a same plane, the first direction X may be a first horizontal direction or a first horizontal length direction of the vibration member 100, and the second direction Y may be a second horizontal direction or a second horizontal length direction of the vibration member 100 which is orthogonal or substantially orthogonal to the first direction X.

The vibration member 100 according to an aspect of the present disclosure may include an entire structure having a same thickness, but aspects of the present disclosure are not limited thereto. For example, the vibration member 100 may include a plate structure having a same thickness throughout its structure, but aspects of the present disclosure are not limited thereto. For example, the vibration member 100 may include a nonplanar structure having a convex portion and/or a concave portion.

According to an aspect of the present disclosure, the vibration member 100 may include a first surface 100a and a second surface 100b. In the vibration member 100, the first surface 100a may be a front surface, a forward surface, a top surface, or an upper surface. The second surface 100b may be a rear surface, a rearward surface, a backside, a back surface, a bottom surface, or a lower surface.

According to an aspect of the present disclosure, the vibration member 100 may be implemented as or realized as a signage panel such as an analog signage, a digital signage, or the like such as an advertising signboard, a poster, a noticeboard, or the like. For example, when the vibration member 100 may be implemented as the signage panel, the analog signage may include signage content such as a sentence, a picture, and a sign, or the like. The signage content may be disposed at the vibration member 100 to be visible or visual. For example, the signage content may be attached on one or more of the first surface 100a and the second surface 100b of the vibration member 100. For example, the signage content may be directly attached on the first surface 100a of the vibration member 100. For example, the signage content may be printed on a medium such as paper or the like, and the medium with the signage content printed thereon may be directly attached on the first surface 100a of the vibration member 100. For example, when the signage content is attached on the first surface 100a of the vibration member 100, the vibration member 100 may be configured as a transparent material.

A vibration member 100 according to one aspect of the present disclosure may include two or more materials. The vibration member 100 may include a multilayer structure including different materials. For example, the vibration member 100 may include two or more members including two or more different materials. The vibration member 100 may include a central portion and an outer portion including different materials. For example, the vibration member 100 may be configured to have a core-shell structure. For example, the vibration member 100 may have a core-shell structure of different materials.

The vibration apparatus 500 may be configured to vibrate the vibration member 100. The vibration apparatus 500 may be disposed or configured at the vibration member 100. The vibration apparatus 500 may be configured to vibrate (or displace or drive) based on a driving signal (or an electrical signal, which may convey an electrical voice signal, or a sound wave signal) applied thereto to vibrate (or displace or drive) the vibration member 100. For example, the vibration apparatus 500 may be one or more of an active vibration member, a vibration generator, a vibration structure, a vibrator, a vibration generating device, a sound generator, a sound device, a sound generating structure, or a sound generating device, but aspects of the present disclosure are not limited thereto.

The vibration apparatus 500 according to an aspect of the present disclosure may include a piezoelectric material or an electroactive material, which has a piezoelectric characteristic. The vibration apparatus 500 may autonomously vibrate (or displace or drive) based on a vibration (or displacement or driving) of the piezoelectric material based on a driving signal applied to the piezoelectric material, or may vibrate (or displace or drive) the vibration member 100 or the like.

The vibration apparatus 500 may alternately repeat contraction and/or expansion based on a piezoelectric effect (or a piezoelectric characteristic) to vibrate (or displace or drive). For example, the vibration apparatus 500 may vibrate (or displace or drive) in the third direction Z (e.g., a vertical direction or a thickness direction) as contraction and/or expansion are alternately repeated by an inverse piezoelectric effect.

The vibration apparatus 500 according to an aspect of the present disclosure may include a tetragonal shape which has a first length parallel to the first direction X and a second length parallel to the second direction Y. For example, the vibration apparatus 500 may include a square shape where the first length is the same as the second length, but aspects of the present disclosure are not limited thereto. The vibration apparatus 500 may have a relatively smaller size (or area) than the vibration member 100.

The apparatus according to an aspect of the present disclosure may further include a connection member 400.

The connection member 400 may be disposed or connected between the vibration apparatus 500 and the vibration member 100. The connection member 400 may be disposed between the vibration apparatus 500 and the vibration member 100, and may connect or couple the vibration apparatus 500 to the vibration member 100. For example, the vibration apparatus 500 may be connected to or coupled to the vibration member 100 by the connection member 400. For example, the vibration apparatus 500 may be connected to or supported by the second surface 100b of the vibration member 100 by the connection member 400, but aspects of the present disclosure are not limited thereto. For example, the connection member 400 may be a first connection member, a first coupling member, or a first adhesive member, but aspects of the present disclosure are not limited thereto.

The connection member 400 according to an aspect of the present disclosure may include an adhesive layer (or a tacky layer) which is suitable in providing an attaching force or adhesive force. For example, the connection member 400 may be configured as a material including an adhesive layer which is suitable in providing the attaching force or adhesive force, with respect to each of the vibration apparatus 500 and the second surface 100b of the vibration member 100. For example, the connection member 400 may include a foam pad, a double-sided tape, a double-sided foam pad, a double-sided foam tape, an adhesive, a double-sided adhesive, a double-sided adhesive tape, a double-sided adhesive foam pad, a tacky sheet, or the like, but aspects of the present disclosure are not limited thereto. For example, when the connection member 400 includes the tacky sheet (or an adhesive layer), the connection member 400 may include only an adhesive layer or a tacky layer without a base member such as a plastic material or the like.

An adhesive layer of the connection member 400 according to an aspect of the present disclosure may include a pressure sensitive adhesive (PSA), an optically cleared adhesive (OCA), an optically cleared resin (OCR), epoxy resin, acrylic resin, silicone resin, or urethane resin, or the like, but aspects of the present disclosure are not limited thereto. For example, the adhesive layer of the connection member 400 may include an acrylic-based substance (or material) having a characteristic where an adhesive force is relatively better, and hardness is higher. Accordingly, the transfer efficiency of the vibration force (or displacement force) that is transferred from the vibration apparatus 500 to the vibration member 100 may be increased.

The apparatus according to an aspect of the present disclosure may further include a supporting member 300.

The supporting member 300 may be configured or disposed at a rear surface or a surface of the vibration member 100. The supporting member 300 may be configured or disposed at the second surface 100b of the vibration member 100. The supporting member 300 may be configured to support a periphery portion of the second surface 100b of the vibration member 100. The supporting member 300 may be configured to support a periphery portion of a rear surface of the vibration member 100. The supporting member 300 may be configured to cover the vibration apparatus 500 and the second surface 100b of the vibration member 100.

The supporting member 300 according to an aspect of the present disclosure may include an internal space 300S which surrounds the second surface 100b of the vibration member 100. For example, the supporting member 300 may include a box shape where one side (or one portion or an upper side or an upper portion) of the internal space 300S is opened. For example, the supporting member 300 may be a support member, a case, an outer case, a case member, a housing, a housing member, a cabinet, an enclosure, a sealing member, a sealing cap, a sealing box, a sound box, an accommodation member, a receiving member, or the like, but aspects of the present disclosure are not limited thereto. For example, the internal space 300S of the supporting member 300 may be an accommodation space, a receiving space, a gap space, an air space, a vibration space, a sound space, a sound box, a sealing space, a resonance space, or the like, but aspects of the present disclosure are not limited thereto.

The supporting member 300 according to an aspect of the present disclosure may include one or more of a metal material and a nonmetal material (or a composite nonmetal material), but aspects of the present disclosure are not limited thereto. For example, the supporting member 300 may include one or more materials of a metal material, plastic, and wood, but aspects of the present disclosure are not limited thereto.

The supporting member 300 according to an aspect of the present disclosure may include a first supporting part 310 and a second supporting part 330.

The first supporting part 310 may be disposed in parallel with the vibration member 100.

The first supporting part 310 may be disposed to face the second surface 100b of the vibration member 100 and may span the same directions as the vibration member 100 (e.g., the first direction X and the second direction Y). The first supporting part 310 may be disposed to cover the second surface 100b of the vibration member 100. The first supporting part 310 may be spaced apart from the second surface 100b of the vibration member 100. For example, the first supporting part 310 may be spaced apart from the second surface 100b of the vibration member 100 with the internal space 300S therebetween. For example, the first supporting part 310 may be a bottom part, a bottom plate, a supporting plate, a housing plate, a housing bottom part, or the like, but aspects of the present disclosure are not limited thereto.

The second supporting part 330 may be configured or disposed at a periphery portion of the vibration member 100. The second supporting part 330 may be connected to a periphery portion of the first supporting part 310. For example, the second supporting part 330 may include a structure bent from the periphery portion of the first supporting part 310. For example, the second supporting part 330 may be parallel to a third direction Z (e.g., Z-direction as shown in FIGS. 1 and 2), or may be inclined from the third direction Z. For example, the supporting member 300 may include two or more second supporting parts 330. For example, the second supporting part 330 may be a lateral part, a sidewall, a supporting sidewall, a housing lateral surface, a housing sidewall, or the like, but aspects of the present disclosure are not limited thereto.

The second supporting part 330 may be integrated into the first supporting part 310. For example, the first supporting part 310 and the second supporting part 330 may be integrated (or configured) as one body (a single body), and thus, the internal space 300S surrounded by the second supporting part 330 may be provided over the first supporting part 310. Accordingly, the supporting member 300 may include a box shape where one side (or one portion or an upper side or an upper portion) is opened by the first supporting part 310 and the second supporting part 330.

The supporting member 300 may be connected or coupled to the vibration member 100 by a coupling member 200. The supporting member 300 may be connected to or coupled to the second surface 100b of the vibration member 100 by the coupling member 200. For example, the supporting member 300 may be connected to or coupled to a periphery portion of the second surface 100b of the vibration member 100 by the coupling member 200. For example, the second supporting part 330 may be connected to or coupled to the vibration member 100 by the coupling member 200. For example, the second supporting part 330 may be connected to or coupled to the second surface 100b of the vibration member 100 by the coupling member 200. For example, the second supporting part 330 may be connected to or coupled to a periphery portion of the second surface 100b of the vibration member 100 by the coupling member 200.

The coupling member 200 may be configured to minimize, reduce, or prevent the transfer of a vibration of the vibration member 100 to the supporting member 300. The coupling member 200 may include a material characteristic suitable for blocking a vibration. For example, the coupling member 200 may include a material having elasticity. For example, the coupling member 200 may include a material having elasticity for vibration absorption (or impact absorption). The coupling member 200 according to an aspect of the present disclosure may be configured as (or comprise) polyurethane materials and/or polyolefin materials, but aspects of the present disclosure are not limited thereto. For example, the coupling member 200 may include one or more of an adhesive, a double-sided adhesive, a double-sided tape, a double-sided foam tape, a double-sided foam pad, and a double-sided cushion tape, but aspects of the present disclosure are not limited thereto.

The coupling member 200 according to an aspect of the present disclosure may prevent or reduce a physical contact (or friction) between the vibration member 100 and the second supporting part 330 of the supporting member 300, and thus, may prevent or reduce the occurrence of noise (or a noise sound) which may be caused by the physical contact (or friction) between the vibration member 100 and the supporting member 300. For example, the coupling member 200 may be a buffer member, an elastic member, a damping member, a vibration absorption member, a vibration prevention member, or a vibration blocking member, but aspects of the present disclosure are not limited thereto.

The coupling member 200 according to another aspect of the present disclosure may be configured to minimize, reduce, or prevent the transfer of a vibration of the vibration member 100 to the supporting member 300 and to decrease the reflection of an incident sound wave which may be generated based on a vibration of the vibration member 100.

The coupling member 200 according to another aspect of the present disclosure may include a first coupling member 210 and a second coupling member 230.

The first coupling member 210 may be disposed between the vibration member 100 and the supporting member 300. The first coupling member 210 may be disposed between the vibration member 100 and the second supporting part 330 of the supporting member 300. The first coupling member 210 may be disposed or coupled between a rear periphery portion of the vibration member 100 and a second supporting part 330. For example, the first coupling member 210 may be disposed inward (or towards an inner portion of the apparatus) from the second coupling member 230. The first coupling member 210 may be configured to have a hardness which is smaller than that of the second coupling member 230, for example, a modulus (of elasticity) or a Young's modulus (or elastic moduli). For example, the first coupling member 210 may include a double-sided polyurethane tape, a double-sided polyurethane foam tape, a double-sided sponge tape, or the like, but aspects of the present disclosure are not limited thereto.

The second coupling member 230 may be disposed between the vibration member 100 and the supporting member 300. For example, the second coupling member 230 may be disposed between the vibration member 100 and the supporting member 300 to surround the first coupling member 210. The second coupling member 230 may be disposed or coupled between the rear periphery portion of the vibration member 100 and the second supporting part 330 of the supporting member 300. For example, the second coupling member 230 may be disposed or coupled between the rear periphery portion of the vibration member 100 and the second supporting part 330 of the supporting member 300 to surround the first coupling member 210. For example, the second coupling member 230 may be disposed outward (or towards an outer portion of the apparatus) from the first coupling member 210. The second coupling member 230 may be configured to have a hardness which is greater than that of the first coupling member 210, for example, a modulus (of elasticity) or a Young's modulus (or elastic moduli). For example, the second coupling member 230 may include a double-sided polyolefin tape, a double-sided polyolefin foam tape, a double-sided acrylic tape, a double-sided acrylic foam tape, or the like, but aspects of the present disclosure are not limited thereto.

The coupling member 200 according to another aspect of the present disclosure may absorb an incident sound wave which may be generated based on a vibration of the vibration member 100. For example, the first coupling member 210 which is relatively soft and is disposed inward from the second coupling member 230 which is relatively stiff (or harder) may absorb an incident sound wave which may be generated based on a vibration of the vibration member 100.

Thus, a sound (or a wave) generated by being reflected from the coupling member 200 may be minimized or dampened. Accordingly, flatness of a sound pressure level generated based on a vibration of the vibration member 100 may be reduced. For example, the flatness of the sound pressure level may be a magnitude of a deviation between a highest sound pressure level and a lowest sound pressure level within a pitched sound band generated based on a vibration of the vibration member 100.

In the coupling member 200 according to another aspect of the present disclosure, the second coupling member 230 which is relatively stiff may be disposed inward (or towards an inner portion of the apparatus) from the first coupling member 210 which is relatively soft (or softer than the second coupling member 230). Accordingly, a sound pressure level in a specific-pitched sound band of a sound may be reduced. For example, a sound pressure level in a sound band of 2 kHz to 5 kHz and 7 kHz to 12 kHz may be reduced due to a reflected sound (or a reflected wave or a standing wave) generated by being reflected from the second coupling member 230 which is relatively stiff. Therefore, when a reduction in a sound pressure level in a sound band of 2 kHz to 5 kHz and 7 kHz to 12 kHz is needed based on a shape and a size of the vibration member 100, the second coupling member 230 which is relatively stiff may be disposed inward from the first coupling member 210 which is relatively soft. As such, the flatness of the sound pressure level may be improved based on a reduction in a sound pressure level in a sound band of 2 kHz to 5 kHz and 7 kHz to 12 kHz generated by the second coupling member 230.

The apparatus according to an aspect of the present disclosure may generate (or output) a sound according to a vibration of the vibration member 100 based on a vibration of the vibration apparatus 500. The apparatus according to an aspect of the present disclosure may generate (or output) a sound based on a vibration of the vibration member 100. Here, the vibration member 100 may include a plurality of plates configured in different materials to each other. As a result, a sound characteristic and/or a sound pressure level characteristic of the low-pitched sound band (or low-pitched frequency) may be enhanced.

FIG. 3 illustrates a vibration member according to an aspect of the present disclosure.

FIG. 3 is a cross-sectional view illustrating a vibration apparatus and a portion of the vibration member illustrated in FIG. 2 according to an aspect of the present disclosure.

Referring to FIGS. 2 and 3, the vibration member 100 according to an aspect of the present disclosure may comprise an inner member 110 and an outer member 120. For example, the vibration member 100 may include the inner member 110, and the outer member 120 surrounding the inner member 110. For example, the outer member 120 may be configured to surround all surfaces of the inner member 110. For example, when the inner member 110 has an upper surface, a lower surface, and side surfaces, the outer member 120 may be configured to surround the entire upper, lower, and side surfaces of the inner member 110. The outer member 120 may be configured to surround the entire upper surface, lower surface, and side surfaces of the inner member 110. For example, the outer member 120 may be in direct contact (or coupled) to all surfaces of the inner member 110. For example, the outer member 120 may be in direct contact with (or coupled to) all surfaces of the inner member 110 without a medium. For example, the inner member 110 may be inserted into (or embedded to) the inside of the outer member 120, whereby the inner member 110 and the outer member 120 may be integrated into one body.

According to an aspect of the present disclosure, the vibration member 100 may include the core-shell structure by the inner member 110 and the outer member 120. For example, in the vibration member 100 having the core-shell structure, the inner member 110 may correspond to a core, and the outer member 120 may correspond to a shell. For example, the inner member 110 may be a first member, an embedded member, a core member, a central member, a plate, an inner plate, a plate member, a hard member, a hard plate, or a rigid plate, but not limited thereto. For example, the outer member 120 may be a second member, an outer member, a shell member, a protective member, a coating member, an outer plate, a flexible member, an elastic member, a flexible plate, or an elastic plate, but not limited thereto.

According to an aspect of the present disclosure, the inner member 110 and the outer member 120 may include different materials. For example, the inner member 110 and the outer member 120 may have different stiffnesses. For example, the inner member 110 and the outer member 120 may have different densities. For example, the inner member 110 and the outer member 120 may have different modulus or Young's modulus. For example, the inner member 110 and the outer member 120 may be different from each other in any one or more of the stiffness, the density, and the modulus.

According to an aspect of the present disclosure, the inner member 110 may include a metal material. For example, the inner member 110 may be include a metal material including aluminum Al. For example, the inner member 110 may include a material having a density in a range of 1.7 g/cm³ to 2.8 g/cm³ or may be adjusted to 2.0 g/cm³ to 2.5 g/cm³, or 2.25 g/cm³. For example, the inner member 110 may be formed of a material having a modulus in a range of 1 GPa (GigaPascal) to 100 GPa, or may be adjusted to 30 to 70 GPa, or 55 GPa.

According to an aspect of the present disclosure, the outer member 120 may include a soft material having ductile characteristics. For example, the outer member 120 may have a relatively lower stiffness or relatively lower modulus than the inner member 110. For example, the outer member 120 may reduce a dip portion and a peak portion of a sound generated according to the vibration of the vibration apparatus 500 by the ductile characteristics. For example, the outer member 120 may reduce a dip phenomenon and a peak phenomenon in a sound generated according to the vibration of the vibration apparatus 500 by the ductile characteristics. For example, the modulus of the outer member 120 according to an aspect of the present disclosure may be in a range of 2 GPa to 10 GPa, or may be adjusted to 4 GPa to 8 GPa, or 6 GPa. For example, the outer member 120 may include a plastic material. For example, the outer member 120 may include epoxy. For example, the density of the outer member 120 may be in a range of 1.2 g/cm³ to 1.4 g/cm³, or may be adjusted to 1.3 g/cm³.

According to an aspect of the present disclosure, the outer member 120 may be configured to vibrate according to the vibration of the vibration apparatus 500. The outer member 120 may be connected to or coupled to the vibration apparatus 500 by a connection member 400. The connection member 400 may be arranged or connected between the vibration apparatus 500 and a first outer member 121 of the vibration member 100. For example, the vibration apparatus 500 may be connected to or coupled to the second surface 100b of the outer member 120 of the vibration member 100 via the connection member 400.

The vibration apparatus 500 may vibrate the outer member 120, to thereby vibrate the vibration member 100. For example, the vibration apparatus 500 may vibrate the inner member 110 by vibrating the outer member 120. Accordingly, the vibration member 100 may generate (or output) sound by the vibration of the outer member 120 and the inner member 110.

For example, if the vibration member 100 includes only metal material, it is difficult to realize lightness in the vibration member 100 due to thickness and weight, and a defect such as a surface corrosion may occur in the vibration member 100 under a high temperature and humid environment. If the vibration member 100 includes only plastic material, it is easy to realize lightness in the vibration member 100. However, in case of the vibration member 100 including only plastic material, a bending phenomenon may occur in the vibration member 100 after a reliability test, whereby a defect such as a crack may be generated in the vibration apparatus 500, and a deviation of a total sound pressure may be generated according to the strength of the material of the vibration member 100.

According to an aspect of the present disclosure, the vibration member 100 includes the inner member 110 including the metal material and the outer member 120 including the plastic material, and the outer member 120 is configured to surround the entire surface of the inner member 110. Accordingly, the apparatus according to an aspect of the present disclosure may prevent or reduce a corrosion from occurring on the surface of the vibration member 100, and may prevent or reduce a crack from occurring in the vibration apparatus 500 by preventing or reducing the bending phenomenon of the vibration member 100.

According to an aspect of the present disclosure, the outer member 120 may include a first outer member 121 and a second outer member 123. The inner member 110 may be configured between the first outer member 121 and the second outer member 123. The first outer member 121 and the second outer member 123 may be sequentially stacked with the inner member 110 interposed therebetween. For example, the area of each of the first outer member 121 and the second outer member 123 may be greater than the area (or size) of the inner member 110.

According to an aspect of the present disclosure, a thickness T3 and T2 of each of the first outer member 121 and the second outer member 123 may be smaller than a thickness T1 of the inner member 110. For example, in a region (or portion) in which the first outer member 121, the second outer member 123, and the inner member 110 are overlapped each other or stacked vertically (or up and down), the thicknesses T3 and T2 of each of the first outer member 121 and the second outer member 123 may be smaller than the thickness T1 of the inner member 110. For example, the thickness T3 and T2 of a central portion of each of the first outer member 121 and the second outer member 123 overlapped or stacked with the inner member 110 may be smaller than the thickness T1 of the inner member 110.

The first outer member 121 may be configured to surround or cover the first surface (or lower surface) of the inner member 110. The first outer member 121 may be configured to surround or cover the entire first surface (or lower surface) of the inner member 110 and a lower portion of the side surface of the inner member 110. For example, the entire first surface (or lower surface) of the inner member 110 and the lower portion of the side surface of the inner member 110 may be configured to be inserted (or accommodated) into a portion of the first outer member 121.

Accordingly, the entire first surface (or lower surface) of the inner member 110 and the lower portion of the side surface of the inner member 110 may be in contact (or coupled) to the first outer member 121 or may be in direct contact (or coupled) thereto without a medium.

According to an aspect of the present disclosure, the first outer member 121 may include a first surface adjacent to the inner member 110 and a second surface opposite to the first surface.

The first surface of the first outer member 121 may include a groove 121g for accommodating the entire first surface (or lower surface) of the inner member 110 and the lower portion of the side surface of the inner member 110. The groove 121g of the first outer member 121 may have a size corresponding to a size of the inner member 110.

The second surface of the first outer member 121 may be connected (or coupled) to the vibration apparatus 500. The second surface of the first outer member 121 may be configured as a flat surface or a planarized surface, but is not limited thereto.

The second outer member 123 may be configured to surround or cover the second surface (or upper surface) of the inner member 110. The second outer member 123 may be configured to surround or cover the entire second surface (or upper surface) of the inner member 110 and an upper portion of the side surface of the second surface (or upper surface). For example, the entire second surface (or upper surface) of the inner member 110 and the upper portion of the side surface of the inner member 110 may be configured to be inserted (or accommodated) into a portion of the second outer member 123. Accordingly, the entire second surface (or upper surface) of the inner member 110 and the upper portion of the side surface of the inner member 110 may be in contact (or coupled) with the second outer member 123 or may be directly contacted (or coupled) without a medium.

According to an aspect of the present disclosure, the second outer member 123 may include a first surface adjacent to the inner member 110 and a second surface opposite to the first surface.

The first surface of the second outer member 123 may include a groove 123g for accommodating the entire second surface (or upper surface) of the inner member 110 and an upper portion of the side surface of the inner member 110. The groove 123g of the second outer member 123 may have a size corresponding to a size of the inner member 110.

The second surface of the second outer member 123 may be configured as a flat surface or a planarized surface, but not limited thereto.

Each of the first outer member 121 and the second outer member 123 may include a first area A1 and a second area A2. The first area A1 of each of the first outer member 121 and the second outer member 123 may be in contact with (or coupled to) the inner member 110. The second area A2 of each of the first outer member 121 and the second outer member 123 may be configured to surround the side surfaces of the inner member 110. The second area A2 of each of the first outer member 121 and the second outer member 123 may be connected (or coupled) to each other. For example, the second area A2 of each of the first outer member 121 and the second outer member 123 may be directly connected (or coupled) to each other without a medium. When the first outer member 121 and the second outer member 123 include a same material, the second area A2 of the respective first outer member 121 and the second outer member 123 may be combined with each other to form one layer (or one material). Accordingly, the inner member 110 may be completely surrounded by the first outer member 121 and the second outer member 123. For example, when each of the first outer member 121 and the second outer member 123 includes a plastic material, each of the second area A2 of the first outer member 121 and the second area A2 of the second outer member 123 may melt and combine with each other.

The apparatus according to an aspect of the present disclosure may generate (or output) the sound by the vibration of the vibration member 100 according to o the vibration of the vibration apparatus 500. The apparatus according to an aspect of the present disclosure generates (or outputs) the sound according to the vibration of the vibration member 100 including the inner member 110 and the outer member 120 including different materials so that the sound characteristics and/or sound pressure characteristics may be improved and the peak phenomenon and dip phenomenon may be reduced in an entire sound band according as a vibration width (or displacement width) of the vibration member 100 increases due to the ductile characteristics of the outer member 120, thereby improving sound pressure flatness and sound quality of the apparatus.

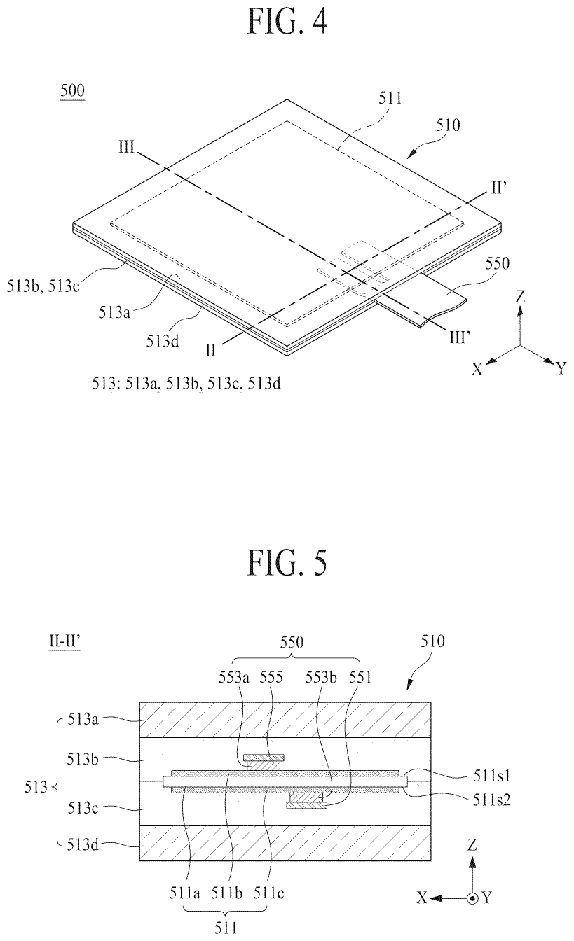

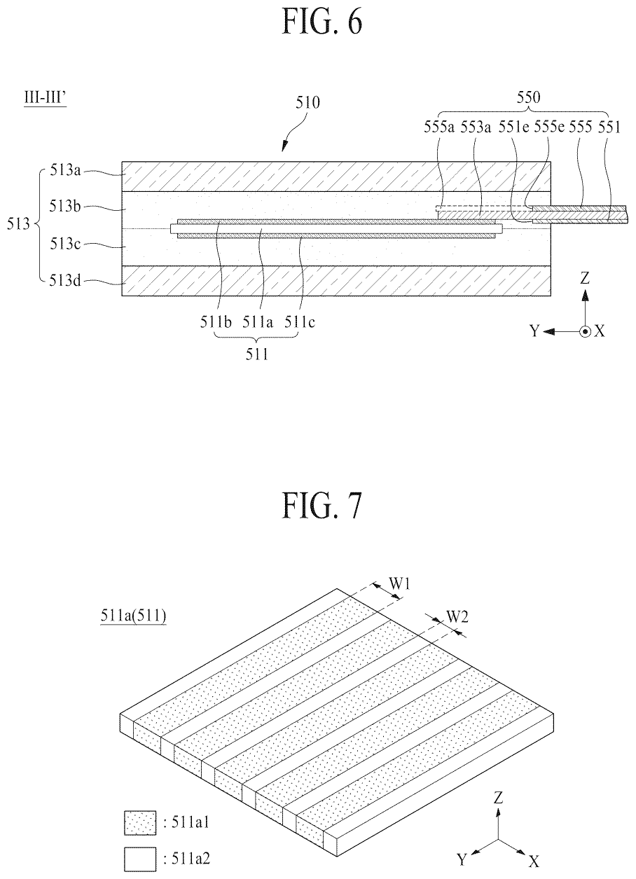

FIG. 4 illustrates a vibration apparatus according to an aspect of the present disclosure. FIG. 5 is a cross-sectional view taken along line II-II′ of FIG. 4 according to an aspect of the present disclosure. FIG. 6 is a cross-sectional view taken along line III-III′ of FIG. 4 according to an aspect of the present disclosure. FIGS. 4 to 6 illustrate the vibration apparatus described above with reference to FIGS. 1 to 3.

Referring to FIGS. 4 to 6, the vibration apparatus 500 according to an aspect of the present disclosure may include a vibration generating part 510.

The vibration generating part 510 may include a piezoelectric material having a piezoelectric characteristic. The vibration generating part 510 may be configured as a ceramic-based piezoelectric material for implementing a relatively strong vibration, or may be configured as a piezoelectric ceramic having a perovskite-based crystal structure. For example, the vibration generating part 510 may be a vibration generating device, a vibration film, a vibration generating film, a vibrator, a vibration generator, an active vibrator, an active vibration generator, an actuator, an exciter, a film actuator, a film exciter, an ultrasonic actuator, an active vibration member, or the like, but aspects of the present disclosure are not limited thereto.

The vibration generating part 510 according to an aspect of the present disclosure may include a vibration part 511.

The vibration part 511 may be configured to vibrate in response to a driving signal due to a piezoelectric effect. The vibration part 511 may include at least one or more of a piezoelectric inorganic material and a piezoelectric organic material. For example, the vibration part 511 may be a vibration element, a piezoelectric device, a piezoelectric element, a piezoelectric device part, a piezoelectric device layer, a piezoelectric structure, a piezoelectric vibration part, or a piezoelectric vibration layer, but aspects of the present disclosure are not limited thereto.

The vibration part 511 according to an aspect of the present disclosure may include a vibration layer 511a, a first electrode layer 511b, and a second electrode layer 511c.

The vibration layer 511a may include a piezoelectric material or an electroactive material which includes a piezoelectric effect. For example, the piezoelectric material may have a characteristic in which, when a pressure or twisting phenomenon is applied to a crystalline structure by an external force, a potential difference occurs due to dielectric polarization caused by a relative position change of a positive (+) ion and a negative (−) ion, and thus a vibration is generated by an electric field based on a reverse voltage applied thereto. For example, the vibration layer 511a may be a piezoelectric layer, a piezoelectric material layer, an electroactive layer, a piezoelectric composite layer, a piezoelectric composite, or a piezoelectric ceramic composite, or the like, but aspects of the present disclosure are not limited thereto.

The vibration layer 511a may be configured as a ceramic-based material for implementing a relatively strong vibration (e.g., strong amplitude vibration), or may be configured as a piezoelectric ceramic having a perovskite-based crystalline structure. The perovskite-based crystalline structure may have a piezoelectric effect and/or an inverse piezoelectric effect and may be a plate-shaped structure having an orientation.

The piezoelectric ceramic may be configured as a single crystalline ceramic having a crystalline structure, or may be configured as a ceramic material having a polycrystalline structure or a polycrystalline ceramic. A piezoelectric material including the single crystalline ceramic may include α-AlPO₄, α-SiO₂, LiNbO₃, Tb₂(MoO₄)₃, Li₂B₄O₇, or ZnO, but aspects of the present disclosure are not limited thereto. A piezoelectric material including the polycrystalline ceramic may include a lead zirconate titanate (PZT)-based material, including lead (Pb), zirconium (Zr), and/or titanium (Ti), or may include a lead zirconate nickel niobate (PZNN)-based material, including lead (Pb), zirconium (Zr), nickel (Ni), and/or niobium (Nb), but aspects of the present disclosure are not limited thereto. For example, the vibration layer 511a may include at least one or more of calcium titanate (CaTiO₃), barium titanate (BaTiO₃), and strontium titanate (SrTiO₃), without lead (Pb), but aspects of the present disclosure are not limited thereto.

The first electrode layer 511b may be disposed at a first surface (or an upper surface or a front surface) 511si of the vibration layer 511a. The first electrode layer 511b may have a same size as that of the vibration layer 511a, or may have a size which is smaller than that of the vibration layer 511a.

The second electrode layer 511c may be disposed at a second surface (or a lower surface or a rear surface) 511s2 which is opposite to or different from the first surface 511si of the vibration layer 511a. The second electrode layer 511c may have a same size as that of the vibration layer 511a, or may have a size which is smaller than that of the vibration layer 511a. For example, the second electrode layer 511c may have a same or similar shape as the vibration layer 511a, but aspects of the present disclosure are not limited thereto.

According to an aspect of the present disclosure, to prevent or reduce electrical short circuit between the first electrode layer 511b and the second electrode layer 511c, each of the first electrode layer 511b and the second electrode layer 511c may be formed at another portion, except a periphery portion, of the vibration layer 511a. For example, the first electrode layer 511b may be formed at an entire first surface 511s1, other than a periphery portion, of the vibration layer 511a. For example, the second electrode layer 511c may be formed at an entire second surface 511s2, other than a periphery portion, of the vibration layer 511a. For example, a distance between a lateral surface (or a sidewall) of each of the first electrode layer 511b and the second electrode layer 511c and a lateral surface (or a periphery, perimeter or sidewall) of the vibration layer 511a may be at least 0.5 mm or more. For example, the distance between the lateral surface of each of the first electrode layer 511b and the second electrode layer 511c and the lateral surface of the vibration layer 511a may be at least 1 mm or more, but aspects of the present disclosure are not limited thereto.

According to an aspect of the present disclosure, one or more of the first electrode layer 511b and the second electrode layer 511c may include a transparent conductive material, a semitransparent conductive material, or an opaque conductive material. For example, the transparent conductive material or the semitransparent conductive material may include indium tin oxide (ITO) or indium zinc oxide (IZO), but aspects of the present disclosure are not limited thereto. The opaque conductive material may include gold (Au), silver (Ag), platinum (Pt), palladium (Pd), molybdenum (Mo), magnesium (Mg), carbon, or silver (Ag) including glass frit, or the like, or may include an alloy thereof, but aspects of the present disclosure are not limited thereto. For example, to enhance an electrical characteristic and/or a vibration characteristic of the vibration layer 511a, each of the first electrode layer 511b and the second electrode layer 511c may include silver (Ag) having a low resistivity. For example, carbon may include one or more of carbon black, ketjen black, carbon nanotube, and a carbon material including graphite, but aspects of the present disclosure are not limited thereto.

The vibration layer 511a may be polarized (or poling) by a certain voltage applied to the first electrode layer 511b and the second electrode layer 511c in a certain temperature atmosphere, or a temperature atmosphere that may be changed from a high temperature to a room temperature, but aspects of the present disclosure are not limited thereto. For example, a polarization direction (or a poling direction) formed in the vibration layer 511a may be formed or aligned (or arranged) from the first electrode layer 511b to the second electrode layer 511c, but is not limited thereto, and a polarization direction (or a poling direction) formed in the vibration layer 511a may be formed or aligned (or arranged) from the second electrode layer 511c to the first electrode layer 511b.

The vibration layer 511a may alternately and repeatedly contract and/or expand due to an inverse piezoelectric effect according to a driving signal applied to the first electrode layer 511b and the second electrode layer 511c from an outside to vibrate. For example, the vibration layer 511a may vibrate in a vertical direction (or thickness direction) and in a planar direction by the signal applied to the first electrode layer 511b and the second electrode layer 511c. The vibration layer 511a may be displaced (or vibrated or driven) by contraction and/or expansion of the planar direction, thereby improving a sound characteristic and/or a sound pressure level characteristic of the vibration generating part 510.

The vibration generating part 510 according to an aspect of the present disclosure may further include a cover member 513.

The cover member 513 may be configured to cover at least one or more of the first surface and second surface of the vibration part 511. The cover member 513 may be configured to protect at least one or more of the first surface and second surface of the vibration part 511. For example, the first surface of the vibration part 511 may be a front surface or top surface. For example, the second surface of the vibration part 511 may be a rear surface, a back surface, or a bottom surface opposite to the first surface.

The cover member 513 according to an aspect of the present disclosure may include a first cover member 513a.

The first cover member 513a may be disposed at a first surface of the vibration part 511. For example, the first cover member 513a may be configured to cover the first electrode layer 511b of the vibration part 511. For example, the first cover member 513a may be configured to have a larger size than the vibration part 511. The first cover member 513a may be configured to protect the first surface of the vibration part 511 and the first electrode layer 511b.

A first cover member 513a according to an aspect of the present disclosure may comprise an adhesive layer. For example, the first cover member 513a may include a base film, and an adhesive layer provided on the base film and connected or coupled to a first surface of a vibration part 511. For example, the adhesive layer may include an electrical insulating material capable of being compressed and decompressed and having an adhesive property.

A first cover member 513a according to another aspect of the present disclosure may be connected to or coupled to a first surface of a vibration part 511 via a first adhesive layer 513b. For example, the first cover member 513a may be connected to or coupled to the first surface of the vibration part 511 or the first electrode layer 511b by the first adhesive layer 513b. For example, the first cover member 513a may be connected to or coupled to the first surface of the vibration part 511 or the first electrode layer 511b by a film laminating process by the first adhesive layer 513b. The first adhesive layer 513b may be configured to surround the entire first surface of the vibration part 511 and a portion of the side surface of the vibration part 511.

A cover member 513 according to an aspect of the present disclosure may further include a second adhesive layer 513c.

The second adhesive layer 513c may be arranged on a second surface of the vibration part 511. For example, the second adhesive layer 513c may be configured to cover a second electrode layer 511c of the vibration part 511. The second adhesive layer 513c may be configured to protect the second surface and the second electrode layer 511c of the vibration part 511. The second adhesive layer 513c may be configured to surround the entire second surface of the vibration part 511 and a portion of a side surface of the vibration part 511. For example, the second adhesive layer 513c may be a protective layer or a protective member.

The second adhesive layer 513c may be connected to or coupled to the first adhesive layer 513b at the side surface of the vibration part 511 or the edge (or the periphery) of the first cover member 513a. Thus, the first adhesive layer 513b and the second adhesive layer 513c may be configured to surround or completely surround the vibration part 511. The first adhesive layer 513b and the second adhesive layer 513c may be configured to cover or surround all surfaces of the vibration part 511. For example, the vibration part 511 may be inserted (or accommodated) or buried (or embedded) in the inside of the adhesive layer including the first adhesive layer 513b and the second adhesive layer 513c.

The cover member 513 may be connected to or coupled to the vibration member 100 via the connection member 400 illustrated in FIGS. 2 and 3. For example, any one of the first cover member 513a and the second adhesive layer 513c may be connected to or coupled to the vibration member 100 via the connection member 400 illustrated in FIGS. 2 and 3.

The cover member 513a according to an aspect of the present disclosure may further include a second cover member 513d, but not limited thereto.

The second cover member 513d may be disposed on the second surface of the vibration part 511. For example, the second cover member 513d may be configured to cover the second electrode layer 511c of the vibration part 511. For example, the second cover member 513d may be configured to have a larger size than the vibration part 511 and may be configured to have the same size as the first cover member 513a. The second cover member 513d may be configured to protect the second surface of the vibration part 511 and the second electrode layer 511c.

Each of the first cover member 513a and the second cover member 513d may include the same material or a different material. For example, each of the first cover member 513a and the second cover member 513d may be or include a polyimide film or a polyethylene terephthalate film, but aspects of the present disclosure are not limited thereto.

The second cover member 513d may be connected or coupled to the second surface of the vibration part 511 or the second electrode layer 511c by a second adhesive layer 513c. For example, the second cover member 513d may be connected to or coupled to the second surface of the vibration part 511 or the second electrode layer 511c by a film laminating process by the second adhesive layer 513c.

The vibration part 511 may be disposed or inserted (or accommodated) between the first cover member 513a and the second cover member 513d. For example, the vibration part 511 may be inserted (or accommodated) or embedded (or embedded) in the adhesive layer including the first adhesive layer 513b and the second adhesive layer 513c.

Each of the first adhesive layer 513b and second adhesive layer 513c according to an aspect of the present disclosure may include an electrically insulating material which has adhesiveness and is capable of compression and decompression. For example, each of the first adhesive layer 513b and the second adhesive layer 513c may include an epoxy resin, an acrylic resin, a silicone resin, a urethane resin, pressure sensitive adhesive PSA, optically cleared adhesive OCA, or optically cleared resin OCR, but aspects of the present disclosure are not limited thereto.

The first adhesive layer 513b and second adhesive layer 513c may be configured between the first cover member 513a and the second cover member 513d to surround the vibration part 511. For example, one or more of the first adhesive layer 513b and second adhesive layer 513c may be configured to surround the vibration part 511.

Any one of the first cover member 513a and the second cover member 513d may be connected to or coupled to the vibration member 100 by the connection member 400 illustrated in FIGS. 2 and 3.

The vibration apparatus 500 or a vibration generating part 510 according to an aspect of the present disclosure may each further include a signal supply member 550.

The signal supply member 550 may be configured to supply the driving signal supplied from a driving circuit part to the vibration part 511. The signal supply member 550 may be configured to be electrically connected to the vibration part 511. The signal supply member 550 may be configured to be electrically connected to the first electrode layer 511b and the second electrode layer 511c.

A portion of the signal supply member 550 may be accommodated (or inserted) between the cover member 513 and the vibration part 511. For example, the portion of the signal supply member 550 may be accommodated (or inserted) between the first cover member 513a and the first surface of the vibration part 511. For example, the portion of the signal supply member 550 may be accommodated (or inserted) between the first cover member 513a and the second cover member 513d.

According to an aspect of the present disclosure, an end portion (or a distal end portion or one side or one portion) of the signal supply member 550 may be disposed or inserted (or accommodated) between one edge portion (or one periphery portion) of the first cover member 513a and the vibration part 511. For example, an end portion (or a distal end portion or one side or one portion) of the signal supply member 550 may be disposed or inserted (or accommodated) between one edge portion (or one periphery portion) of the first cover member 513a and the first surface of the vibration part 511.

An end portion (or a distal end portion or one side or one portion) of the signal supply member 550 may be disposed or inserted (or accommodated) between one edge portion (or one periphery portion) of the first cover member 513a and one edge portion (or one periphery portion) of the second cover member 513d. The one edge portion of the first cover member 513a and the one edge portion of the second cover member 513d may accommodate or vertically (or up and down) cover the end portion (or the distal end portion or the one side or one portion) of the signal supply member 550. Accordingly, the signal supply member 550 may be configured (or integrated) as one body with the vibration generating part 510. For example, the signal supply member 550 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but aspects of the present disclosure are not limited thereto.

The signal supply member 550 according to an aspect of the present disclosure may include a base member 551 and a plurality of signal lines 553a and 553b. For example, the signal supply member 550 may include a base member 551, a first signal line 553a, and a second signal line 553b.

The base member 551 may include a transparent or opaque plastic material, but aspects of the present disclosure are not limited thereto. The base member 551 may have a certain width along a first direction X and may be extended long along a second direction Y intersecting with the first direction X.

The first and second signal lines 553a and 553b may be disposed at the first surface of the base member 551 in parallel with the second direction Y, and may be spaced apart from each other or electrically separated from each other along the first direction X. The first and second signal lines 553a and 553b may be disposed in parallel to each other at the first surface of the base member 551. For example, the first and second signal lines 553a and 553b may be implemented in a line shape by patterning of a metal layer (or a conductive layer) formed or deposited at the first surface of the base member 551.

End portions (or distal end portions or one sides or one portions) of the first and second signal lines 553a and 553b may be separated from each other, and thus, may be individually curved or bent.

The end portion (or the distal end portion or the one side or one portion) of the first signal line 553a may be electrically connected to the first electrode layer 511b of the vibration part 511. For example, the end portion of the first signal line 553a may be electrically connected to at least a portion of the first electrode layer 511b of the vibration part 511 at or near one edge portion of the first cover member 513a. For example, the end portion (or the distal end portion or the one side or one portion) of the first signal line 553a may be electrically and directly connected to at least a portion of the first electrode layer 511b of the vibration part 511. For example, the end portion (or the distal end portion or the one side or one portion) of the first signal line 553a may be electrically connected to or directly contact the first electrode layer 511b of the vibration part 511. For example, the end portion of the first signal line 553a may be electrically connected to the first electrode layer 511b by a conductive double-sided tape. Accordingly, the first signal line 553a may be configured to transfer a first driving signal, supplied from a vibration driver, to the first electrode layer 511b of the vibration part 511.

The end portion (or the distal end portion or the one side or one portion) of the second signal line 553b may be electrically connected to the second electrode layer 511c of the vibration part 511. For example, the end portion of the second signal line 553b may be electrically connected to at least a portion of the second electrode layer 511c of the vibration part 511 at one edge portion of the second cover member 513d. For example, the end portion of the second signal line 553b may be electrically and directly connected to at least a portion of the second electrode layer 511c of the vibration part 511. For example, the end portion of the second signal line 553b may be electrically connected to or directly contact the second electrode layer 511c of the vibration part 511. For example, the end portion of the second signal line 553b may be electrically connected to the second electrode layer 511c by a conductive double-sided tape. Accordingly, the second signal line 553b may be configured to transfer a second driving signal, suppled from the vibration driver, to the second electrode layer 511c of the vibration part 511.

The signal supply member 550 according to an aspect of the present disclosure may further include an insulation layer 555.

The insulation layer 555 may be disposed at the first surface of the base member 551 to cover each of the first signal line 553a and the second signal line 553b other than the end portion (or one side or one portion) of the signal supply member 550.

According to an aspect of the present disclosure, an end portion (or one side or one portion) of the signal supply member 550 including an end portion (or one side or one portion) of the base member 551 and an end portion (or one side or one portion) 555a of the insulation layer 555 may be inserted (or accommodated) between the first cover member 513a and the second cover member 513d and may be fixed between the first cover member 513a and the second cover member 513d by the first adhesive layer 513b and the second adhesive layer 513c. Accordingly, the end portion (or one side or one portion) of the first signal line 553a may be maintained with being electrically connected to the first electrode layer 511b of the vibration part 511, and the end portion (or one side or one portion) of the second signal line 553b may be maintained with being electrically connected to the second electrode layer 511c of the vibration part 511. Further, the end portion (or one side or one portion) of the signal supply member 550 may be inserted (or accommodated) and fixed between the vibration part 511 and the first cover member 513a, and thus, a contact defect between the vibration generating part 510 and the signal supply member 550 caused by the movement of the signal supply member 550 may be prevented or reduced.

In the signal supply member 550 according to an aspect of the present disclosure, each of the end portion (or one side or one portion) of the base member 551 and the end portion (or one side or one portion) 555a of the insulation layer 555 may be removed. For example, each of the end portion of the first signal line 553a and the end portion of the second signal line 553b may be exposed at the outside (e.g., next to the end of the vibration part 511) without being supported or covered by each of the end portion (or one side) of the base member 551 and the end portion (or one side or one portion) 555a of the insulation layer 555, respectively. For example, the end portion of each of the first and second signal lines 553a and 553b may protrude (or extend) to have a certain length from an end 551e of the base member 551 or an end 555e of the insulation layer 555. Accordingly, each of the end portion (or the distal end portion or the one side or one portion) of each of the first and second signal lines 553a and 553b may be individually or independently curved (or bent).

The end portion (or one side or one portion) of the first signal line 553a, which is not supported by the end portion (or one side or one portion) of the base member 551 and the end portion 555a of the insulation layer 555, may be directly connected to or directly contact the first electrode layer 511b of the vibration part 511. The end portion (or one side or one portion) of the second signal line 553b, which is not supported by the end portion (or one side or one portion) of the base member 551 and the end portion 555a of the insulation layer 555, may be directly connected to or directly contact the second electrode layer 511c of the vibration part 511.

According to an aspect of the present disclosure, a portion of the signal supply member 550 or a portion of the base member 551 may be disposed or inserted (or accommodated) between the cover member 513 and the vibration part 511, and thus, the signal supply member 550 may be configured (or integrated) as one body with the vibration apparatus 500. For example, a portion of the signal supply member 550 or a portion of the base member 551 may be disposed or inserted (or accommodated) between the first cover member 513a and the second cover member 513d, and thus, the signal supply member 550 may be configured (or integrated) as one body with the vibration generating part 510. Accordingly, the vibration generating part 510 and the signal supply member 550 may be configured as one part (or an element or a one component), and thus, an effect of uni-materialization may be obtained.

According to an aspect of the present disclosure, the first signal line 553a and the second signal line 553b of the signal supply member 550 may be configured (or integrated) as one body with the vibration generating part 510, and thus, a soldering process for an electrical connection between the vibration generating part 510 and the signal supply member 550 may not be needed.

Accordingly, a manufacturing process and a structure of the vibration apparatus 500 may be simplified, and thus, the expense, time and hazards associated with a soldering process are avoided.

FIG. 7 illustrates a vibration layer according to another aspect of the present disclosure. FIG. 7 illustrates another example of the vibration layer described above with reference to FIGS. 4 to 6.

Referring to FIGS. 4 and 7, the vibration layer 511a according to another aspect of the present disclosure may include a plurality of first portions 511a1 and a plurality of second portions 511a2. For example, the plurality of first portions 511a1 and the plurality of second portions 511a2 may be alternately and repeatedly disposed along a first direction X (e.g., X-direction) or a second direction Y (e.g., Y-direction).

Each of the plurality of first portions 511a1 may include an inorganic material portion having a piezoelectric effect (or a piezoelectric characteristic). For example, each of the plurality of first portions 511a1 may include at least one or more of a piezoelectric inorganic material and a piezoelectric organic material. For example, each of the plurality of first portions 511a1 may be an inorganic portion, an inorganic material portion, a piezoelectric portion, a piezoelectric material portion, or an electroactive portion, but aspects of the present disclosure are not limited thereto.

According to an aspect of the present disclosure, each of the plurality of first portions 511a1 may have a first width W1 parallel to the first direction X (or the second direction Y) and may be extended along the second direction Y (or the first direction X). Each of the plurality of first portions 511a1 may include a material which is substantially the same as a vibration layer 511a described above with reference to FIGS. 4 to 6, and thus, repeated descriptions thereof are omitted or may be briefly discussed.

Each of the plurality of second portions 511a2 may be disposed between the plurality of first portions 511a1. For example, each of the plurality of first portions 511a1 may be disposed between two adjacent second portions 511a2 of the plurality of second portions 511a2. Each of the plurality of second portions 511a2 may have a second width W2 parallel to the first direction X (or the second direction Y) and may be extended along the second direction Y (or the first direction X). The first width W1 may be the same as or different from the second width W2. For example, the first width W1 may be greater than the second width W2. For example, the first portion 511a1 and the second portion 511a2 may include a line shape or a stripe shape which has the same size or different sizes. For example, the first portion 511a1 and the second portion 511a2 may be shaped as a line or as stripes with either equal-sized or different-sized stripes.

Each of the plurality of second portions 511a2 may be configured to fill a gap between two adjacent first portions of the plurality of first portions 511a1. Each of the plurality of second portions 511a2 may be configured to fill a gap between two adjacent first portions of the plurality of first portions 511a1, and thus, may be connected to or attached on lateral surfaces of the first portion 511a1 adjacent thereto. In this manner, the first and second portions 511a1 and 511a2 may be alternatingly disposed in strips. According to an aspect of the present disclosure, each of the plurality of first portions 511a1 and the plurality of second portions 511a2 may be disposed (or arranged) at a same plane (or a same layer) in parallel with each other. Therefore, the vibration layer 511a may be expanded to a desired size or length by a lateral coupling (or connection) of first portions 511a1 and second portions 511a2.

According to an aspect of the present disclosure, each of the plurality of second portions 511a2 may absorb an impact applied to the first portions 511a1, and thus, may enhance the total durability of the first portions 511a1 and provide flexibility to the vibration layer 511a. Each of the plurality of second portions 511a2 may include an organic material having a ductile (e.g., soft and/or elastic) characteristic. For example, each of the plurality of second portions 511a2 may include one or more of an epoxy-based polymer, an acrylic-based polymer, and a silicone-based polymer, but aspects of the present disclosure are not limited thereto. For example, each of the plurality of second portions 511a2 may be an organic portion, an organic material portion, an adhesive portion, a stretch portion, a bending portion, a damping portion, or a ductile (e.g., soft and/or elastic) portion, but aspects of the present disclosure are not limited thereto.

A first surface of each of the plurality of first portions 511a1 and the plurality of second portions 511a2 may be connected to the first electrode layer 511b in common. A second surface of each of the plurality of first portions 511a1 and the plurality of second portions 511a2 may be connected to the second electrode layer 511c in common.

The plurality of first portions 511a1 and the plurality of second portion 511a2 may be disposed on (or connected to) the same plane, and thus, the vibration layer 511a according to another aspect of the present disclosure may have a single thin film-type. Accordingly, the vibration part 511 or the vibration generating part 510 including the vibration layer 511a according to another aspect of the present disclosure may vibrate by the first portion 511a1 having a vibration characteristic and may be bent in a curved shape by the second portion 511a2 having flexibility.

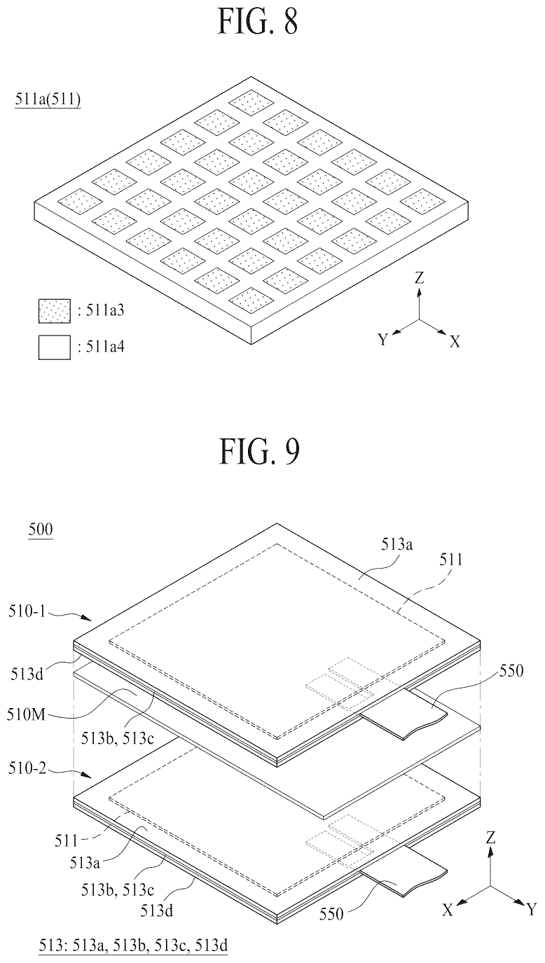

FIG. 8 illustrates a vibration layer according to another aspect of the present disclosure. FIG. 8 illustrates another example of the vibration layer (e.g., 511a) described above with reference to FIGS. 4 to 6.

Referring to FIGS. 4 and 8, the vibration layer 511a according to another aspect of the present disclosure may include a plurality of first portions 511a3 and a second portion 511a4 disposed between the plurality of first portions 511a3.

Each of the plurality of first portions 511a3 may be disposed to be spaced apart from one another along each of the first direction X and the second direction Y. For example, each of the plurality of first portions 511a3 may have a hexahedral shape having the same size (e.g., a cube shape) and may be disposed in a lattice shape, but aspects of the present disclosure are not limited thereto. In an example, from the top view, each first portion 511a3 may have a square shape. For example, each of the plurality of first portions 511a3 may have a circular shape plate, an oval shape plate, or a polygonal shape plate, which has the same size as each other, but aspects of the present disclosure are not limited thereto.

Each of the plurality of first portions 511a3 may include a material which is be substantially the same as the first portion 511a1 described above with reference to FIG. 7, and thus, repeated descriptions thereof are omitted or may be briefly discussed.

The second portion 511a4 may be disposed between the plurality of first portions 511a3 along each of the first direction X and the second direction Y. The second portion 511a4 may be configured to fill a gap between two adjacent first portions 511a3 or to surround each of the plurality of first portions 511a3, and thus, the second portion 511a4 may be connected to or attached on the first portion 511a3 adjacent thereto. For instance, the first portions 511a3 are arranged in rows and columns and the second portion 511a4 surround all of such first portions 511a3 as shown in FIG. 8, and such a configuration may be referred to herein as a lattice configuration. The second portion 511a4 may include a material which is be substantially the same as the second portion 511a2 described above with reference to FIG. 7, and thus, repeated descriptions thereof are omitted or may be briefly discussed.

A first surface of each of the plurality of first portions 511a3 and the second portions 511a4 may be connected to the first electrode layer 511b in common. A second surface of each of the plurality of first portions 511a3 and the second portions 511a4 may be connected to the second electrode layer 511c in common.

The plurality of first portions 511a3 and the second portion 511a4 may be disposed on (or connected to) the same plane, and thus, the vibration layer 511a according to another aspect of the present disclosure may have a single thin film-type. Accordingly, the vibration part 511 or the vibration generating part 510 including the vibration layer 511a according to another aspect of the present disclosure may vibrate by the first portion 511a3 having a vibration characteristic and may be bent in a curved shape by the second portion 511a4 having flexibility.

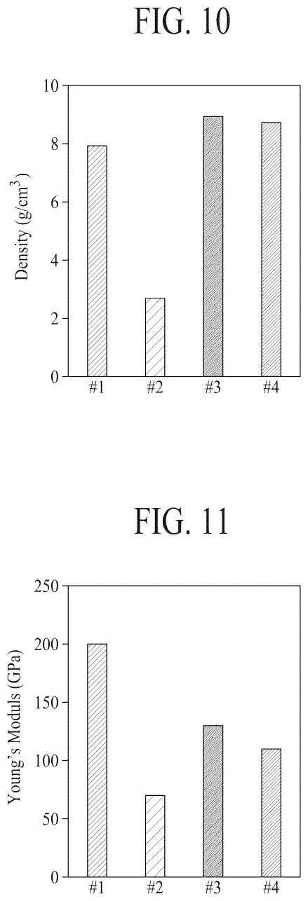

FIG. 9 illustrates a vibration apparatus according to another aspect of the present disclosure. FIG. 9 illustrates another example of the vibration apparatus or the plurality of vibration generating apparatuses described above with reference to FIGS. 1 to 3.

Referring to FIGS. 2 and 9, the vibration apparatus 500 according to another aspect of the present disclosure may include two or more vibration generating parts 510-1 and 510-2. For example, the vibration apparatus 500 may include a first vibration generating part 510-1 and a second vibration generating part 510-2.

The first vibration generating part 510-1 and the second vibration generating part 510-2 may overlap or be stacked with each other to be displaced (or driven or vibrated) in a same direction to maximize or increase an amplitude displacement of the vibration apparatus 500. For example, the first vibration generating part 510-1 and the second vibration generating part 510-2 may have substantially the same size, but aspects of the present disclosure are not limited thereto. For example, the first vibration generating part 510-1 and the second vibration generating part 510-2 may have substantially the same size within an error range of a manufacturing process. Therefore, the first vibration generating part 510-1 and the second vibration generating part 510-2 may maximize or increase an amplitude displacement of the vibration apparatus 500.

According to an aspect of the present disclosure, any one of the first vibration generating part 510-1 and the second vibration generating part 510-2 may be connected or coupled to a vibration member 100 by a connection member 400 illustrated in FIG. 2. For example, the first vibration generating part 510-1 may be connected to or coupled to the vibration member 100 by the connection member 400.

Each of the first vibration generating part 510-1 and the second vibration generating part 510-2 may be the same as or substantially the same as the vibration generating part 510 described above with reference to FIGS. 4 to 6, and thus, like reference numeral refer to like element and repeated descriptions thereof are omitted or may be briefly discussed.

The vibration apparatus 500 according to another aspect of the present disclosure may further include an intermediate adhesive member 510M.

The intermediate adhesive member 510M may be disposed or connected between the first vibration generating part 510-1 and the second vibration generating part 510-2. According to one aspect of the present disclosure, the intermediate adhesive member 510M may be disposed or connected between the second adhesive layer 513c of the first vibration generating part 510-1 and the first cover member 513a of the second vibration generating part 510-2. According to another aspect of the present disclosure, the intermediate adhesive member 510M may be disposed or connected between the second cover member 513d of the first vibration generating part 510-1 and the first cover member 513a of the second vibration generating part 510-2. For example, the intermediate adhesive member 510M may be an intermediate member, an adhesive member, or a connection member, but aspects of the present disclosure are not limited thereto.

The intermediate adhesive member 510M according to an aspect of the present disclosure may be configured in a material including an adhesive layer which is good in adhesive force or attaching force with respect to each of the first vibration generating part 510-1 and the second vibration generating part 510-2. For example, the intermediate adhesive member 510M may include a foam pad, a double-sided tape, a double-sided foam tape, a double-sided foam pad, a double-sided adhesive tape, an adhesive, or the like, but aspects of the present disclosure are not limited thereto. For example, an adhesive layer of the intermediate adhesive member 510M may include epoxy resin, acrylic resin, silicone resin, or urethane resin, but aspect of the present disclosure are not limited thereto. For example, the adhesive layer of the intermediate adhesive member 510M may include a urethane-based material (or substance) having relatively ductile (e.g., soft and/or elastic) characteristic. Accordingly, the adhesive layer may minimize or reduce vibration loss due to displacement interferences between the first vibration generating part 510-1 and the second vibration generating part 510-2, allowing each of the first vibration generating part 510-1 and the second vibration generating part 501-2 to displace (or drive or vibrate) freely and independently.

The vibration apparatus 500 according to another aspect of the present disclosure may include the first vibration generating part 510-1 and the second vibration generating part 510-2 which are stacked (or overlap or piled) to vibrate (or displace or drive) in a same direction, and thus, the amount of displacement or an amplitude displacement may be maximized or increase.

Accordingly, the amount of displacement (or a bending force or a driving force) or an amplitude of displacement of the vibration member may be maximized or increased.

FIG. 10 illustrates a density of an inner member according to an experimental example.

FIG. 11 illustrates a modulus of an inner member according to an experimental example. This illustrates the density and modulus of the inner member described with reference to FIG. 3.

The inventor of the present disclosure prepared samples in experimental examples 1 to 4 to configure a material suitable for the inner member. The inventor of the present disclosure manufactured the inner members of experimental examples 1 to 4 by using SUS, aluminum, copper, and brass, and prepared the apparatus for Experimental examples 1 to 4 by combining the inner members with the vibration apparatus and the supporting member. A thickness in each of the inner members of experimental examples 1 to 4 is 0.3 mm, each vertical and horizontal length in each of the inner members is 30 cm, a thickness ratio of the vibration apparatus and the inner member is 0.55, and an area ratio of the vibration apparatus and the inner member is 0.08. For example, the thickness ratio of the vibration apparatus and the inner member is defined as a value obtained by dividing the thickness of the vibration apparatus by the thickness of the inner member. For example, the area ratio of the vibration apparatus and the inner member is defined as a value obtained by dividing the area of the vibration apparatus by the area of the inner member. In FIGS. 10 and 11, experimental examples 1 to 4 are represented by #1 to #4, respectively.

Referring to FIG. 10, the density of experimental example 1 (or SUS) is 7.93 g/cm³, the density of experimental example 2 (or aluminum) was 2.69 g/cm³, the density of experimental example 3 (or copper) is 8.93 g/cm³, and the density of experimental example 4 (or brass) is 8.73 g/cm³. Accordingly, it is confirmed that the densities of experimental examples 3 and 4 are similar and the density of experimental example 2 is relatively lower.

Referring to FIG. 11, the modulus of experimental example 1 (or SUS) is 200 GPa, the modulus of experimental example 2 (or aluminum) is 70 GPa, the modulus of experimental example 3 (or copper) is 130 GPa, and the modulus of experimental example 4 (or brass) is 110 GPa. Accordingly, it is confirmed that the modulus of experimental examples 3 and 4 was similar, and the modulus of experimental example 2 is relatively low.

The following Table 1 shows the average sound pressure level SPL (dB) characteristic for each frequency (Hz) in the apparatus including the inner member according to experimental examples 1 to 4.

TABLE 1

| Frequency (Hz) | | 0.15~20k | 0.15~10k | 0.3~0.8k | 1~10k | 2~4k | 0.15~8k |
|---|---|---|---|---|---|---|---|
| Average | Experimental | 77.65 | 75.72 | 77.60 | 77.59 | 81.07 | 76.60 |
| Sound | example 1 | | | | | | |
| Pressure | Experimental | 83.58 | 78.92 | 84.76 | 85.82 | 85.10 | 82.36 |
| Level | example 2 | | | | | | |
| SPL (dB) | Experimental | 74.82 | 70.63 | 75.39 | 76.15 | 71.19 | 73.34 |
| | example 3 | | | | | | |
| | Experimental | 73.90 | 71.98 | 75.65 | 73.85 | 73.78 | 72.66 |
| | example 4 | | | | | | |

Referring to Table 1, the average sound pressure level SPL (dB) for each frequency (Hz) of the apparatus including the inner member including SUS according to experimental example 1 is measured as 77.65 dB from 0.15 kHz to 20 kHz, 75.72 dB from 0.15 kHz to 10 kHz, 77.60 dB from 0.3 kHz to 0.8 kHz, 77.59 dB from 1 kHz to 10 kHz, 81.07 dB from 2 kHz to 4 kHz, and 76.60 dB from 0.15 kHz to 8 kHz. Accordingly, it is checked that the sound pressure characteristic of experimental example 1 is lower than that of experimental example 2 and is higher than that of Experimental examples 3 and 4. The average sound pressure level SPL (dB) for each frequency (Hz) of the apparatus including the inner member including aluminum according to experimental example 2 is measured as 83.58 dB from 0.15 kHz to 20 kHz, 78.92 dB from 0.15 kHz to 10 kHz, 84.76 dB from 0.3 kHz to 0.8 kHz, 85.82 dB from 1 kHz to 10 kHz, 85.10 dB from 2 kHz to 4 kHz, and 82.36 dB from 0.15 kHz to 8 kHz. Accordingly, in case of a sample including aluminum of experimental example 2, it may be confirmed that high sound pressure characteristic is represented compared to other experimental examples.

The average sound pressure level SPL (dB) for each frequency (Hz) of the apparatus including the inner member including copper of experimental example 3 is measured as 74.82 dB from 0.15 kHz to 20 kHz, 70.63 dB from 0.15 kHz to 10 kHz, 75.39 dB from 0.3 kHz to 0.8 kHz, 76.15 dB from 1 kHz to 10 kHz, 71.19 dB from 2 kHz to 4 kHz, and 73.34 dB from 0.15 kHz to 8 kHz. Accordingly, experimental example 3 shows that the sound pressure characteristic whose sound pressure value is lower than that of experimental examples 1 and 2 and is similar to that of experimental example 4.

The average sound pressure level SPL (dB) for each frequency (Hz) of the apparatus including the inner member including brass of experimental example 4 is measured as 73.90 dB from 0.15 kHz to 20 kHz, 71.98 dB from 0.15 kHz to 10 kHz, 75.65 dB from 0.3 kHz to 0.8 kHz, 73.85 dB from 1 kHz to 10 kHz, 73.78 dB from 2 kHz to 4 kHz, and 72.66 dB from 0.15 kHz to 8 kHz. Accordingly, experimental example 4 shows that the sound pressure characteristic whose sound pressure value is lower than that of experimental examples 1 and 2 and is similar to that of experimental example 3.

Accordingly, referring to FIGS. 10 and 11, and Table 1, the inventor of the present disclosure confirms that an inner member including a material having a density in a range of 1.7 g/cm³ to 2.8 g/cm³ and a modulus of 1 GPa to 100 GPa has higher sound pressure characteristics as compared to other materials.

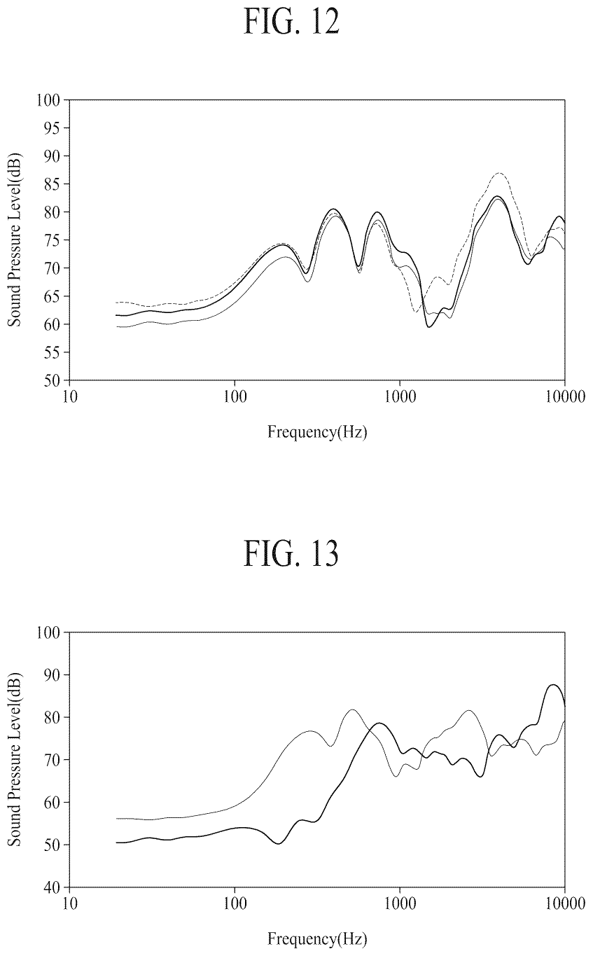

FIG. 12 illustrates sound pressure characteristics of an apparatus according to an experimental example.

The inventor of the present disclosure prepared samples of experimental example 5, experimental example 6, and experimental example 7 by differently setting the configuration of vibration member to form a material suitable for an outer member. A vibration member of experimental example 5 includes only an inner member, and each vibration member of experimental examples 6 and 7 includes an inner member and an outer member. In each experimental example, SUS is used for the inner member, polyethylene terephthalate PET is used for the outer member of experimental example 6, and epoxy is used for the outer member of experimental example 7. In experimental example 5, a thickness of the inner member is 0.5 mm, each horizontal and vertical length of the vibration member is 30 cm, a thickness ratio of the vibration apparatus and the inner member is 0.33, and an area ratio of the vibration apparatus and the inner member is 0.08. A thickness of the inner member in each of experimental examples 6 and 7 is 0.5 mm, a thickness of the outer member is 0.15 mm, each horizontal and vertical length of the vibration member is 30 cm, a thickness ratio of the vibration apparatus and vibration member is 0.25, and an area ratio of the vibration apparatus and vibration member is 0.12. In FIG. 12, a dotted line is the sound pressure characteristic of experimental example 5, a thin solid line is the sound pressure characteristic of experimental example 6, and a thick solid line is the sound pressure characteristic of experimental example 7. For example, the density of PET (polyethylene terephthalate) and epoxy is 1.1 g/cm³ and 1.21.1 g/cm³, respectively, and the modulus is 2.0 GPa and 2.4 GPa, respectively.

Referring to FIG. 12, at a frequency of 0.1 kHz or less, experimental example 6 and experimental example 7 represent the sound pressure characteristic which is lower than that of experimental example 5. However, at a frequency exceeding 0.1 kHz, it may be seen that the sound characteristic of experimental example 7 represents the same level of sound pressure characteristic of experimental example 5.

The following Table 2 shows the characteristic of average sound pressure level SPL (dB) for each frequency (Hz) of the apparatus including the vibration member according to experimental example 5, experimental example 6, and experimental example 7.

TABLE 2

| Frequency (Hz) | | 0.15~20k | 0.15~10k | 0.3~0.8k | 1~10k | 2~4k | 0.15~8k |
|---|---|---|---|---|---|---|---|
| Average | Experimental | 75.50 | 74.42 | 76.10 | 74.83 | 79.14 | 74.53 |
| Sound | example5 | | | | | | |
| Pressure | Experimental | 73.41 | 73.59 | 75.97 | 71.73 | 73.52 | 72.46 |
| Level | example 6 | | | | | | |
| SPL (dB) | Experimental | 74.40 | 75.21 | 77.21 | 72.61 | 75.07 | 73.51 |
| | example 7 | | | | | | |

Referring to Table 2, the average sound pressure level SPL (dB) for each frequency (Hz) of the apparatus configured to surround the inner member by the outer member including PET of experimental example 6 is measured as 72.46 dB at 0.15 kHz to 8 kHz, and 73.41 dB at 0.15 kHz to 20 kHz. Accordingly, it may be seen that the sound pressure characteristic of experimental example 6 is lower than the sound pressure characteristic of experimental example 5 by about 2 dB. The average sound pressure level SPL (dB) for each frequency Hz of the apparatus configured to surround the inner member by the outer member including epoxy of experimental example 7 is measured as 73.51 dB at 0.15 kHz to 8 kHz and 74.40 dB at 0.15 kHz to 20 kHz. Accordingly, it may be seen that the sound pressure characteristic of experimental example 7 is similar to the sound pressure characteristic of experimental example 5 and is higher than the sound pressure characteristic of experimental example 6.

Accordingly, if providing the outer member configured to surround the inner member and providing the outer member using a material having a density in the range of 1.2 g/cm³ to 1.4 g/cm³ and a modulus of 2 GPa to 10 GPa, the inventor of the present disclosure may provide an apparatus capable of preventing or reducing a crack from being generated in a vibration apparatus by preventing or reducing a bending phenomenon of a vibration member while maintaining sound pressure characteristics of the vibration apparatus and capable of preventing or reducing rust from being generated on a surface of the vibration member under high temperature and high humidity conditions.

FIG. 13 illustrates sound output characteristics of an apparatus according to an experimental example.

The inventor of the present disclosure prepared samples in experimental example 8 and experimental example 9 to compare sound pressure characteristics of the apparatus according to an area ratio of vibration member and vibration apparatus. The vibration member of experimental examples 8 and 9 comprises an inner member and an outer member. Herein, SUS is used for the inner member, and epoxy is used for the outer member. In the experimental examples 8 and 9, a thickness of the inner member is 0.3 mm, a thickness of the outer member is 0.15 mm, and a thickness ratio of the inner member and the outer member is 0.33. In the experimental example 8, each of horizontal and vertical lengths of the vibration member is 30 cm, and an area ratio of the vibration apparatus and the vibration member is 0.08. In the experimental example 9, horizontal and vertical lengths of the vibration member are 20 cm and 30 cm, respectively, and an area ratio of the vibration apparatus and the vibration member is 0.12. In FIG. 13, a thin solid line represents the sound pressure characteristic of experimental example 8, and a thick solid line represents the sound pressure characteristic of experimental example 8.

The following Table 3 shows the average sound pressure level SPL (dB) characteristic for each frequency (Hz) in the apparatus including the vibration members of experimental examples 8 and 9.

TABLE 3

| Frequency (Hz) | | 0.15~20k | 0.15~10k | 0.3~0.8k | 1~10k | 2~4k | 0.15~8k |
|---|---|---|---|---|---|---|---|
| Average | Experimental | 75.14 | 74.43 | 77.16 | 74.54 | 77.37 | 74.39 |
| Sound | example 8 | | | | | | |
| Pressure | Experimental | 71.47 | 63.56 | 68.18 | 74.45 | 70.18 | 68.55 |
| Level | example 9 | | | | | | |
| SPL (dB) | | | | | | | |

Referring to FIG. 13 and Table 3, the average sound pressure level SPL (dB) for each frequency (Hz) of sample of which the respective horizontal and vertical lengths of the vibration member of experimental example 8 are 30 cm and 30 cm is measured as 75.14 dB at 0.15 kHz to 20 kHz, 74.43 dB at 0.15 kHz to 10 kHz, 77.16 dB at 0.3 kHz to 0.8 kHz, 74.54 dB at 1 kHz to 10 kHz, 77.37 dB at 2 kHz to 4 kHz, and 74.39 dB at 0.15 kHz to 8 kHz. The size of the vibration member is not limited to the contents of the present disclosure.

The average sound pressure level SPL (dB) for each frequency (Hz) of sample of which the respective horizontal and vertical lengths of the vibration member of experimental example 9 are 20 cm and 30 cm is measured as 71.47 dB at 0.15 kHz to 20 kHz, 63.56 dB at 0.15 kHz to 10 kHz, 68.18 dB at 0.3 kHz to 0.8 kHz, 74.45 dB at 1 kHz to 10 kHz, 70.18 dB at 2 kHz to 4 kHz, and 68.55 dB at 0.15 kHz to 8 kHz. The size of the vibration member is not limited to the contents of the present disclosure.

According to the experimental examples 8 and 9, the sound pressure characteristics of experimental examples 8 and 9 are 75.14 dB and 71.47 dB at 0.15 kHz to 20 kHz, whereby it may be confirmed that the sound pressure characteristics of experimental example 8 is high. However, the sound pressure characteristics of experimental examples 8 and 9 are 74.45 dB and 74.45 dB at 1 kHz to 10 kHz, respectively, whereby it may be confirmed that the sound pressure characteristics of the experimental examples 8 and 9 are similar. Also, as shown in FIG. 13, it may be confirmed that the flatness of the graph curve of the experimental example 9 is excellent at 1 kHz to 10 kHz. Accordingly, in case of the experimental example 9 compared to experimental example 8, it may be confirmed that a dip portion and a peak portion of sound generated according to vibration are reduced. According to an aspect of the present disclosure, it is confirmed that the sound pressure characteristic for each frequency of experimental example 8 is high, but the sound pressure flatness at 1 kHz to 10 kHz is high in the experimental example 9.

Accordingly, the inventor of the present disclosure can confirm that, when the area ratio of the vibration apparatus and the vibration member is adjusted to be in the range of 0.08 to 0.12, or may be adjusted to 0.09 to 0.11, or 0.10 the sound pressure characteristics of the apparatus are maintained, and the sound pressure flatness and sound quality are improved by reducing the dip and/or peak at 1 kHz to 10 kHz.

FIG. 14 illustrates sound output characteristics of an apparatus according to an aspect of the present disclosure.

The inventor of the present disclosure prepared samples according to the aspects 1 and 2 to compare sound pressure characteristics of the apparatus according to the area of vibration member and vibration apparatus when the inner member includes an aluminum material.

The vibration members of the aspects 1 and 2 include an inner member and an outer member. Herein, aluminum is used for the inner member, and epoxy is used for the outer member. In the aspects 1 and 2, a thickness of the inner member is 0.3 mm, a thickness of the outer member is 0.15 mm, and a thickness ratio of the inner member and the outer member is 0.33. In the aspect 1, horizontal and vertical lengths of the vibration member are 30 cm and 30 cm, respectively, and an area ratio of the vibration apparatus and the vibration member is 0.08. In the aspect 2, horizontal and vertical lengths of the vibration member are 20 cm and 30 cm, respectively, and an area ratio of the vibration apparatus and the vibration member is 0.12. In FIG. 14, a thin solid line represents the sound pressure characteristic of the aspect 1, and a thick solid line represents the sound pressure characteristic of the aspect 2.

The following Table 4 shows the average sound pressure level SPL characteristic for each frequency (Hz) of the apparatus including the vibration members of the aspects 1 and 2.

TABLE 4

| Frequency (Hz) | | 0.15~20k | 0.15~10k | 0.3~0.8k | 1~10k | 2~4k | 0.15~8k |
|---|---|---|---|---|---|---|---|
| Average | Aspect 1 | 80.93 | 77.80 | 82.88 | 81.59 | 81.75 | 79.62 |
| Sound | Aspect 2 | 78.09 | 71.65 | 77.49 | 81.07 | 79.04 | 76.31 |
| Pressure | | | | | | | |
| Level | | | | | | | |
| SPL (dB) | | | | | | | |

Referring to FIG. 14 and Table 4, the average sound pressure level SPL (dB) for each frequency (Hz) of the apparatus including the vibration member of aspect 1 is measured as 80.93 dB at 0.15 kHz to 20 kHz, 77.80 dB at 0.15 kHz to 10 kHz, 82.88 dB at 0.3 kHz to 0.8 kHz, 81.59 dB at 1 kHz to 10 kHz, 81.75 dB at 2 kHz to 4 kHz, and 79.62 dB at 0.15 kHz to 8 kHz.

The average sound pressure level SPL (dB) for each frequency Hz of the apparatus including the vibration member of aspect 2 is measured as 78.09 dB at 0.15 kHz to 20 kHz, 71.65 dB at 0.15 kHz to 10 kHz, 77.49 dB at 0.3 kHz to 0.8 kHz, 81.07 dB at 1 kHz to 10 kHz, 79.04 dB at 2 kHz to 4 kHz, and 76.31 dB at 0.15 kHz to 8 kHz.

According to an aspect of the present disclosure, the sound pressure characteristics of the aspects 1 and 2 are 80.93 dB and 78.09 dB at 0.15 kHz to 20 kHz, whereby it may be confirmed that the sound pressure characteristics of the aspect 1 is high. Also, according to an aspect of the present disclosure, the sound pressure characteristics of the aspects 1 and 2 are 81.59 dB and 81.07 dB at 1 kHz to 10 kHz, respectively, whereby it may be confirmed that the sound pressure characteristics of the aspects 1 and 2 are similar.

Referring to FIG. 14, at 1 kHz to 10 kHz, it may be confirmed that the flatness of the graph curve of the aspect 2 is greater than that of the aspect 1. Accordingly, in case of the aspect 2 compared to the aspect 1, it may be confirmed that a dip portion and a peak portion of sound generated according to vibration are reduced. According to an aspect of the present disclosure, it is confirmed that the sound pressure characteristic for each frequency is high in the aspect 1, but the sound pressure flatness and sound quality is great in the aspect 2 according to the reduction of dip phenomenon and peak phenomenon at 1 kHZ to 10 kHz.

Accordingly, the inventor of the present disclosure may confirm that, when the area ratio of the vibration apparatus and the vibration member is adjusted to be in a range of 0.08 to 0.12, the sound pressure characteristics of the apparatus are maintained, and the sound pressure flatness and sound quality are improved by reducing the dip phenomenon and peak phenomenon at 1 kHz to 10 kHz.

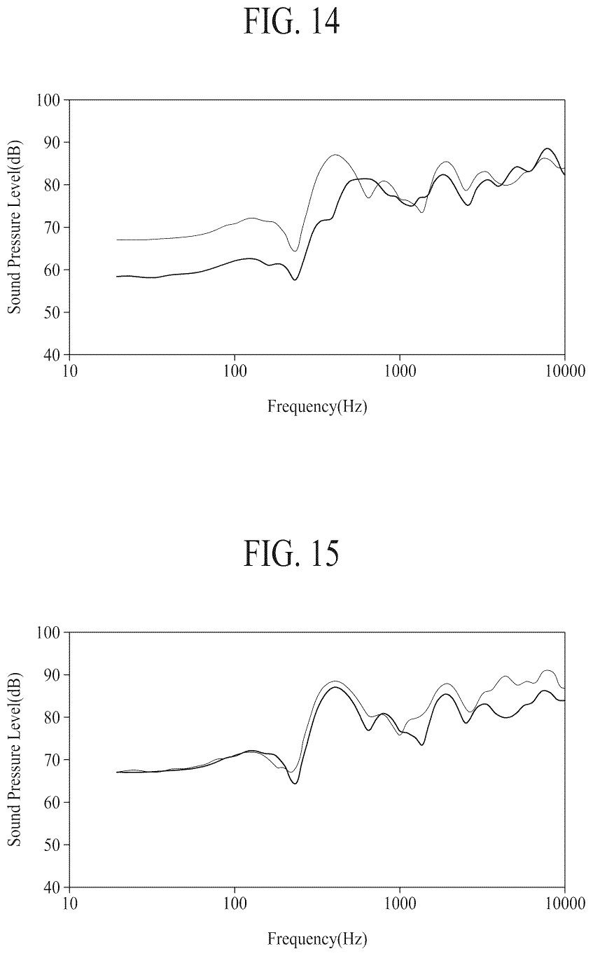

FIG. 15 illustrates sound output characteristics of an apparatus according to an experimental example and an aspect of the present disclosure.

The inventor of the present disclosure prepared samples of experimental example 2 and aspect 1 to compare sound pressure characteristics of the apparatus according to the vibration member. The apparatus including the inner member of experimental example 2 is prepared in the same manner as a comparative example 2 described with reference to Table 1. For example, the experimental example 2 is composed of only the inner member, and aluminum is used for the inner member. In the experimental example 2, each of horizontal and vertical lengths of the vibration member is 30 cm, a thickness ratio of the vibration apparatus and inner member is 0.55, and an area ratio of the vibration apparatus and inner member is 0.08. The vibration member of the aspect 1 is prepared in the same manner as the aspect 1 described with reference to FIG. 14. In FIG. 15, a thin solid line represents a sound pressure characteristic of the experimental example 2, and a thick solid line represents the sound pressure characteristic of the aspect 1.

The following Table 5 shows the average sound pressure level SPL (dB) characteristic for each frequency (Hz) of the apparatus including the vibration member of experimental example 2 and aspect 1.

TABLE 5

| Frequency (Hz) | | 0.15~20k | 0.15~10k | 0.3~0.8k | 1~10k | 2~4k | 0.15~8k |
|---|---|---|---|---|---|---|---|
| Average | Experimental | 83.58 | 78.92 | 84.76 | 85.82 | 85.10 | 82.36 |
| Sound | example 2 | | | | | | |
| Pressure | Aspect 1 | 80.93 | 77.80 | 82.88 | 81.59 | 81.75 | 79.62 |
| Level | | | | | | | |
| SPL (dB) | | | | | | | |

Referring to FIG. 15 and Table 5, the average sound pressure level SPL (dB) for each frequency (Hz) of experimental example 2 is measured as 83.58 dB at 0.15 kHz to 20 kHz, 78.92 dB at 0.15 kHz to 10 kHz, 84.76 dB at 0.3 kHz to 0.8 kHz, 85.82 dB at 1 kHz to 10 kHz, 85.10 dB at 2 kHz to 4 kHz, and 82.36 dB at 0.15 kHz to 8 kHz. The average sound pressure level SPL (dB) for each frequency Hz of aspect 1 is measured as 80.93 dB at 0.15 kHz to 20 kHz, 77.80 dB at 0.15 kHz to 10 kHz, 82.88 dB at 0.3 kHz to 0.8 kHz, 81.59 dB at 1 kHz to 10 kHz, 81.75 dB at 2 kHz to 4 kHz, and 79.62 dB at 0.15 kHz to 8 kHz.

According to an aspect of the present disclosure, it may be confirmed that the sound pressure characteristics of the experimental example 2 is greater than that of the aspect 1 at 0.15 kHZ to 20 kHz. However, the difference in sound pressure characteristics is not large. Also, as shown in FIG. 15, it may be confirmed that it has the similar sound pressure characteristics.

Accordingly, according to an aspect of the present disclosure, when an inner member including a metal material and an outer member including an epoxy material surrounding the inner member are configured, it is possible to realize the similar sound pressure characteristic as compared to that of the vibration member including metal material, and also to prevent or reduce corrosion of the inner member, and to prevent or reduce cracks from being generated in the vibration apparatus by the bending phenomenon of the inner member.

The following Table 6 shows the average sound pressure level SPL (dB) characteristic for each frequency (Hz) according to the material of the inner member. To compare the average sound pressure level SPL (dB) characteristic for each frequency Hz according to the material of the inner member, samples of aspect 1, experimental example 8, experimental example 10, and experimental example 11 are prepared. In Table 6, the aspect 1 is prepared in the same manner as the aspect 1 of Table 5, and the experimental example 8 is prepared in the same manner as the experimental example 8 described with reference to FIG. 13 and Table 3. In Table 6, the respective experimental examples 10 and 11 include the inner member including copper and the inner member including brass, wherein the inner member is inserted into the outer member, and the remaining conditions except for the material of the inner member are prepared in the same manner as the experimental example 8. Accordingly, redundant descriptions thereof will be omitted or may be briefly provided.

TABLE 6

| Frequency (Hz) | | 0.15~20k | 0.15~10k | 0.3~0.8k | 1~10k | 2~4k | 0.15~8k |
|---|---|---|---|---|---|---|---|
| Average | Aspect 1 | 80.93 | 77.80 | 82.88 | 81.59 | 81.75 | 79.62 |
| Sound | Experimental | 75.14 | 74.43 | 77.16 | 74.54 | 77.37 | 74.39 |
| Pressure | Example 8 | | | | | | |
| Level | Experimental | 74.52 | 70.75 | 74.86 | 75.34 | 72.67 | 73.06 |
| SPL (dB) | example 10 | | | | | | |
| | Experimental | 72.91 | 71.22 | 74.31 | 71.93 | 71.88 | 71.26 |
| | example 11 | | | | | | |

Referring to Table 6, the average sound pressure level SPL (dB) for each frequency (Hz) of the apparatus including the inner member of experimental example 10 is measured as 74.52 dB at 0.15 kHz to 20 kHz, 70.75 dB at 0.15 kHz to 10 kHz, 74.86 dB at 0.3 kHz to 0.8 kHz, 75.34 dB at 1 kHz to 10 kHz, 72.67 dB at 2 kHz to 4 kHz, and 73.06 dB at 0.15 kHz to 8 kHz. The average sound pressure level SPL (dB) for each frequency Hz of the apparatus including the inner member of experimental example 11 is measured as 72.91 dB at 0.15 kHz to 20 kHz, 71.22 dB at 0.15 kHz to 10 kHz, 74.31 dB at 0.3 kHz to 0.8 kHz, 71.93 dB at 1 kHz to 10 kHz, 71.88 dB at 2 kHz to 4 kHz, and 71.26 dB at 0.15 kHz to 8 kHz.

Referring to Table 6, in the apparatus in which the vibration member including the inner member and an outer member is configured, it may be confirmed that the sound pressure characteristic according to the material of the inner member has the highest sound pressure characteristic in the aspect 1 in which the inner member includes aluminum. In addition, in the apparatus having the vibration member including the inner member and the outer member, it may be confirmed that the sound pressure characteristic according to the material of the inner member represents the highest sound pressure characteristic in the case including aluminum similarly to the case in which the vibration member is configured only with metal plate described with reference to Table 1.

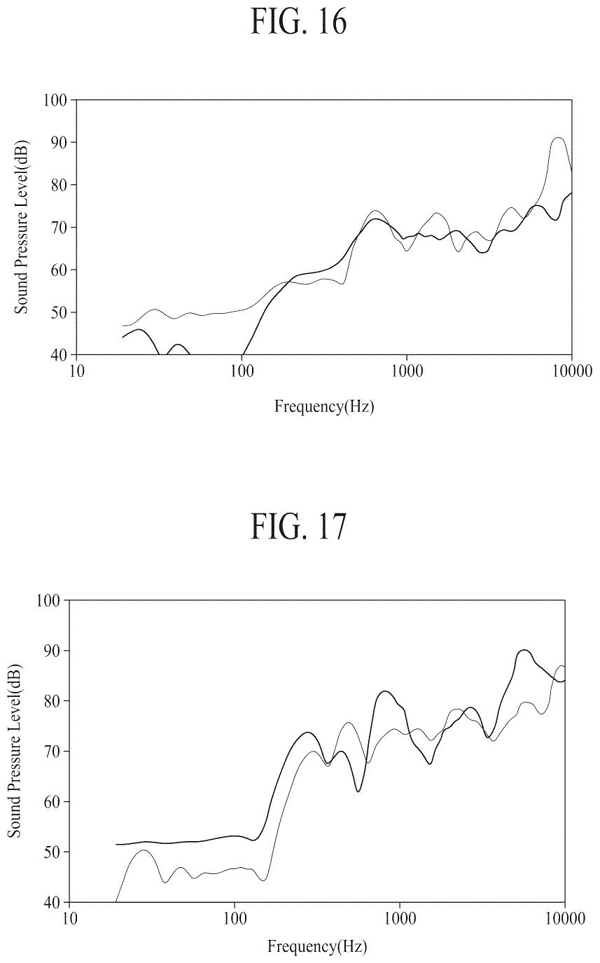

FIG. 16 illustrates sound output characteristics of an apparatus according to an experimental example and an aspect of the present disclosure.

The inventor of the present disclosure prepared samples of experimental example 11 and aspect 2 to compare sound pressure characteristics of the vibration member configured to have the inner member including aluminum and the outer member surrounding the inner member. The vibration member of experimental example 11 includes only the inner member, and aluminum is used for the inner member. In the experimental example 11, a thickness of the inner member is 0.3 mm, respective horizontal and vertical lengths of the vibration member is 20 cm and 30 cm, a thickness ratio of the vibration apparatus and vibration member is 0.55, and an area ratio of the vibration apparatus and vibration member is 0.12. The vibration member of the aspect 2 is prepared in the same manner as the aspect 2 described with reference to FIG. 14. In FIG. 16, a thin solid line represents the sound pressure characteristic of the experimental example 11, and a thick solid line represents the sound pressure characteristic of the aspect 2.

The following Table 7 shows the average sound pressure level SPL (dB) characteristic for each frequency (Hz) of the apparatus including the vibration members of experimental example 11 and aspect 2.

TABLE 7

| Frequency (Hz) | | 0.15~20k | 0.15~10k | 0.3~0.8k | 1~10k | 2~4k | 0.15~8k |
|---|---|---|---|---|---|---|---|
| Average | Experimental | 81.90 | 76.88 | 80.90 | 85.08 | 84.23 | 80.97 |
| Sound | example 11 | | | | | | |
| Pressure | Aspect 2 | 78.09 | 71.65 | 77.49 | 81.07 | 79.04 | 76.31 |
| Level | | | | | | | |
| SPL (dB) | | | | | | | |

According to FIG. 16 and Table 7, the average sound pressure level SPL (dB) for each frequency (Hz) of the apparatus including the vibration member of experimental example 11 is measured as 81.90 dB at 0.15 kHz to 20 kHz, 76.88 dB at 0.15 kHz to 10 kHz, 80.90 dB at 0.3 kHz to 0.8 kHz, 85.08 dB at 1 kHz to 10 kHz, 84.23 dB at 2 kHz to 4 kHz, and 80.97 dB at 0.15 kHz to 8 kHz. The average sound pressure level SPL (dB) for each frequency Hz of the apparatus including the vibration member of aspect 2 is measured as 78.09 dB at 0.15 kHz to 20 kHz, 71.65 dB at 0.15 kHz to 10 kHz, 77.49 dB at 0.3 kHz to 0.8 kHz, 81.07 dB at 1 kHz to 10 kHz, 79.04 dB at 2 kHz to 4 kHz, and 76.31 dB at 0.15 kHz to 8 kHz.

According to an aspect of the present disclosure, it may be confirmed that the sound pressure characteristic of experimental example 11 is higher than that of aspect 2 at 0.15 kHz to 20 kHz. However, in the aspect 2 as compared with the experimental example 11 at 0.15 kHz to 20 kHz, it may be confirmed that dip and peak portions of the sound generated according to the vibration are reduced.

Accordingly, according to an aspect of the present disclosure, when the inner member and the outer member surrounding the inner member are configured, the dip and peak portions of the sound generated according to the vibration are reduced so that the sound pressure flatness and the sound quality may be improved.

Accordingly, the apparatus according to an aspect of the present disclosure comprises the inner member including metal material, and the outer member formed of epoxy material surrounding the inner member, thereby having sound pressure characteristics similar to that of the case using the vibration member including metal material, preventing or reducing corrosion of the vibration member, and preventing or reducing cracks from occurring in the vibration apparatus by the bending phenomenon of the vibration member.

The following Table 8 shows the average sound pressure level SPL (dB) characteristic for each frequency (Hz) according to the material of the inner member. The inventor of the present disclosure prepared samples of aspect 2, experimental example 9, experimental example 12, and experimental example 13 to confirm the average sound pressure level SPL (dB) characteristic for each frequency (Hz) according to the material of the inner member.

In Table 8, the aspect 2 is prepared in the same manner as the aspect 2 of FIG. 14 and Table 4, and the experimental example 9 is prepared in the same manner as the experimental example 9 described with reference to FIG. 13 and Table 3. In Table 8, the respective experimental examples 12 and 13 include the inner member including copper and the inner member including brass, and the inner member is inserted into the outer member, and the remaining conditions except for the material of the inner member are prepared in the same manner as those of the experimental example 9. In the aspects and experimental examples of Table 8, the area of the vibration member is different from that of Table 6, and the remaining conditions are the same. Accordingly, redundant descriptions thereof will be omitted or may be briefly provided. The area or size of the vibration member is not limited to the contents of the present disclosure.

TABLE 8

| Frequency (Hz) | | 0.15~20k | 0.15~10k | 0.3~0.8k | 1~10k | 2~4k | 0.15~8k |
|---|---|---|---|---|---|---|---|
| Average | Aspect 2 | 78.09 | 71.65 | 77.49 | 81.07 | 79.04 | 76.31 |
| Sound | Experimental | 71.47 | 63.56 | 68.18 | 74.45 | 70.18 | 68.55 |
| Pressure | example 9 | | | | | | |
| Level | Experimental | 68.74 | 63.67 | 66.79 | 69.99 | 67.17 | 66.58 |
| SPL (dB) | example 12 | | | | | | |
| | Experimental | 69.97 | 62.90 | 65.87 | 72.01 | 66.47 | 66.81 |
| | example 13 | | | | | | |

Referring to Table 8, the average sound pressure level SPL (dB) for each frequency (Hz) of experimental example 12 is measured as 68.74 dB at 0.15 kHz to 20 kHz, 63.67 dB at 0.15 kHz to 10 kHz, 66.79 dB at 0.3 kHz to 0.8 kHz, 66.99 dB at 1 kHz to 10 kHz, 67.17 dB at 2 kHz to 4 kHz, and 66.58 dB at 0.15 kHz to 8 kHz. The average sound pressure level SPL (dB) for each frequency Hz of experimental example 13 is measured as 69.97 dB at 0.15 kHz to 20 kHz, 62.90 dB at 0.15 kHz to 10 kHz, 65.87 dB at 0.3 kHz to 0.8 kHz, 72.01 dB at 1 kHz to 10 kHz, 66.47 dB at 2 kHz to 4 kHz, and 66.81 dB at 0.15 kHz to 8 kHz.

Referring to Table 8, in the apparatus in which the vibration member including the inner member and an outer member is configured, it may be confirmed that the sound pressure characteristic according to the material of the inner member has the highest sound pressure characteristic in the case in which the inner member includes aluminum. Referring to Table 6 and Table 8, in the apparatus having the vibration member including the inner member and the outer member, it may be confirmed that the sound pressure characteristic according to the material of the inner member represents the highest sound pressure characteristic in the case including the inner member of aluminum regardless of the area of the vibration member with respect to the vibration apparatus.

FIG. 17 illustrates sound output characteristics of an apparatus according to an experimental example. It shows the sound output characteristic of the apparatus including a vibration member including a plastic material.

The inventor of the present disclosure prepares samples of aspect 2, experimental example 14, and experimental example 15 to compare the sound output characteristics of the apparatus including the vibration member including plastic material and an aspect of the present disclosure. The apparatus including the vibration member of aspect 2 is prepared in the same manner as the aspect 2 described with reference to FIG. 14 and Table 4. The inventor of the present disclosure manufactures vibration members of experimental example 14 and experimental example 15 by respectively using polypropylene PP and polyamideimide PAI, and prepares the apparatuses including the vibration members of experimental example 14 and experimental example 15. In the vibration members according to the experimental example 14 and experimental example 15, horizontal and vertical lengths are prepared to be 20 cm and 30 cm, respectively, and a thickness thereof is prepared to be 0.3 mm. In the apparatus including the vibration member according to the experimental example 14 and experimental example 15, a thickness ratio of the vibration apparatus and the vibration member is 0.55, and an area ratio is 0.12. For example, a density of polypropylene PP is 0.9 g/cm³ to 1.2 g/cm³, and a modulus of PP is 4.0 GPa to 10.0 GPa. For example, a density of polyamideimide PAI is 1.4 g/cm³, and a modulus of PAI is 4.0 GPa to 5.0 GPa.

The following Table 9 shows the average sound pressure level SPL (dB) characteristic for each frequency (Hz) of the apparatus including the vibration member according to the aspect 2, experimental example 14, and experimental example 15.

TABLE 9

| Frequency (Hz) | | 0.15~20k | 0.15~10k | 0.3~0.8k | 1~10k | 2~4k | 0.15~8k |
|---|---|---|---|---|---|---|---|
| Average | Aspect 2 | 78.09 | 71.65 | 77.49 | 81.07 | 79.04 | 76.31 |
| Sound | Experimental | 77.76 | 70.86 | 70.61 | 79.18 | 76.55 | 74.85 |
| Pressure | example 14 | | | | | | |
| Level | Experimental | 75.44 | 67.52 | 71.35 | 77.02 | 75.83 | 71.88 |
| SPL (dB) | example 15 | | | | | | |

Referring to Table 9, the average sound pressure level SPL (dB) for each frequency (Hz) of experimental example 14 is measured as 77.76 dB at 0.15 kHz to 20 kHz, 70.86 dB at 0.15 kHz to 10 kHz, 70.61 dB at 0.3 kHz to 0.8 kHz, 79.18 dB at 1 kHz to 10 kHz, 76.55 dB at 2 kHz to 4 kHz, and 74.85 dB at 0.15 kHz to 8 kHz. The average sound pressure level SPL (dB) for each frequency Hz of experimental example 15 is measured as 75.44 dB at 0.15 kHz to 20 kHz, 67.52 dB at 0.15 kHz to 10 kHz, 71.35 dB at 0.3 kHz to 0.8 kHz, 77.02 dB at 1 kHz to 10 kHz, 75.83 dB at 2 kHz to 4 kHz, and 71.88 dB at 0.15 kHz to 8 kHz.

Referring to FIG. 17 and Table 9, in the experimental example 14 and experimental example 15 respectively using polypropylene PP and polyamideimide PAI, the average sound pressure level SPL (dB) for each frequency Hz is high in the experimental example 14, and the sound pressure flatness of the graph is high in the experimental example 15. Accordingly, the average sound pressure is high in polypropylene PP and the sound pressure flatness is high in polyamideimide PAI.

However, the experimental example 14 and experimental example 15 respectively using polypropylene PP and polyamideimide PAI show the lower average sound pressure characteristic and lower sound pressure flatness as compared to those of the aspect 2. Also, in case of the experimental example 14 and experimental example 15 respectively using polypropylene PP and polyamideimide PAI, a bending phenomenon occurs in the vibration member after a reliability test, and a crack is generated in the vibration apparatus due to the bending phenomenon. The reliability test is performed at a temperature of 40° C. to 85° C. for 140 cycles.

Accordingly, the aspect of the present disclosure configures the vibration member including the inner member and the outer member surrounding the inner member so that it is possible to prevent or reduce the bending phenomenon of the vibration member generated after the reliability test and to prevent or reduce the crack from being generated in the vibration apparatus due to the bending phenomenon of the vibration member.

Also, the aspect of the present disclosure configures the vibration member including the inner member and the outer member surrounding the inner member so that it is possible to prevent or reduce corrosion of the vibration member under high temperature and high humidity conditions.

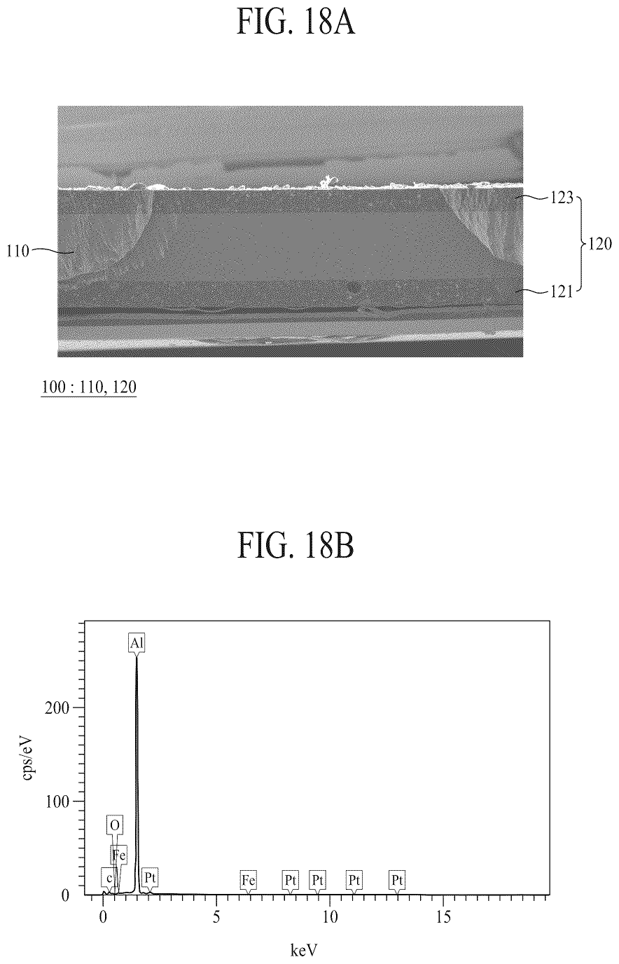

FIG. 18A is a cross-sectional view of the vibration member according to an aspect of the present disclosure. FIG. 18B illustrates an EDS analysis result of the vibration member according to an aspect of the present disclosure. FIG. 18A is a cross-sectional view of the vibration member according to the aspect 2 described with reference to FIG. 14, and FIG. 18B illustrates a component analysis result obtained by analyzing components of the inner member of the vibration member according to the aspect 2 described with reference to FIG. 14.

Referring to FIG. 18A, it may be confirmed that the thickness of the inner member 110 and the outer member 120 is uniformly formed, and the adhesion between the inner member 110 and the outer member 120 is excellent without lifting.

Referring to FIG. 18B, when the inner member 110 includes aluminum Al, the content of aluminum Al is 79.4% and the content of iron Fe is 0.4%.

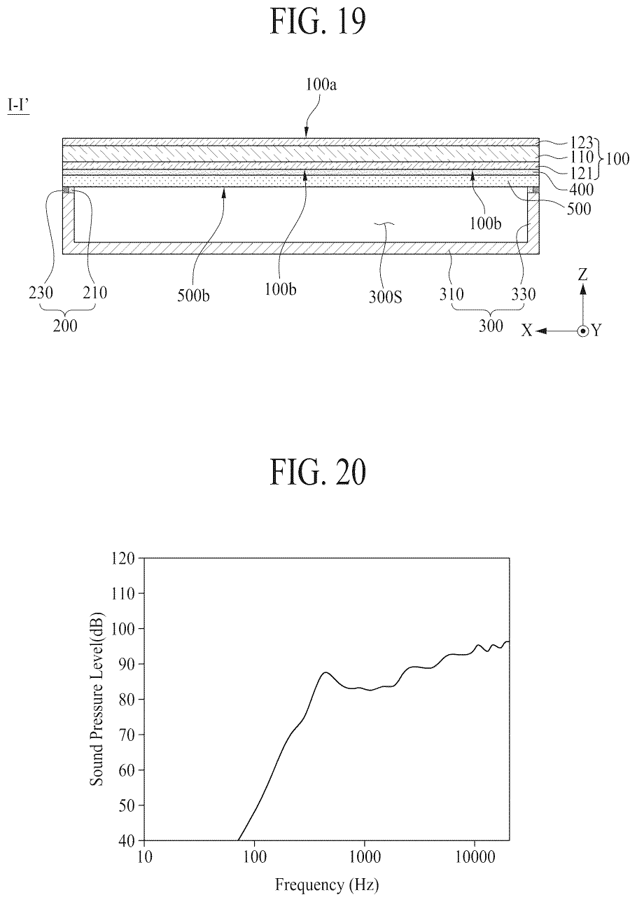

FIG. 19 is a cross-sectional view taken along line VII-VII′ of FIG. 1 according to another aspect of the present disclosure. The apparatus according to another aspect of the present disclosure is substantially the same as the aspect of the present disclosure described with reference to FIG. 2, except that a vibration member 100 and a vibration apparatus 500 have the same area. Thus, a description of the same configuration is omitted or may be briefly provided, and only different configurations are described.

Referring to FIG. 19, the vibration member 100 according to another aspect of the present disclosure may be configured to have substantially the same area as the vibration apparatus 500. For example, the vibration apparatus 500 may be formed on a second surface 100b of the vibration member 100. For example, the vibration apparatus 500 may be configured on the entire surface of the second surface 100b of the vibration member 100. For example, the vibration apparatus 500 may be connected to or coupled to the entire surface of the second surface 100b of the vibration member 100 via a connection member 400.

A supporting member 300 may be configured or arranged on the rear surface of the vibration member 100. The supporting member 300 may be configured or arranged on the rear surface of the vibration apparatus 500. The supporting member 300 may be configured to support an edge portion of a second surface 500b of the vibration apparatus 500. The supporting member 300 may be configured to support the edge portion of the rear surface of the vibration member 100 and the vibration apparatus 500. The supporting member 300 may be configured to cover the second surface 500b of the vibration apparatus 500.

The supporting member 300 according to another aspect of the present disclosure may include an inner space 300S surrounding the second surface 500b of the vibration apparatus 500.

A first supporting part 310 according to another aspect of the present disclosure may be arranged in parallel with the vibration apparatus 500. The first supporting part 310 may be arranged to face the second surface 500b of the vibration apparatus 500. The first supporting part 310 may be arranged to cover the second surface 500b of the vibration apparatus 500. The first supporting part 310 may be spaced apart from the second surface 500b of the vibration apparatus 500. For example, the first supporting part 310 may be spaced apart from the second surface 500b of the vibration apparatus 500 with the inner space 300S therebetween.

A second supporting part 330 according to another aspect of the present disclosure may be configured or arranged at an edge portion (or a periphery portion) of the vibration apparatus 500.

The supporting member 300 may be connected to or coupled to the vibration apparatus 500 via a coupling member 200. The supporting member 300 may be connected to or coupled to the second surface 500b of the vibration apparatus 500 via the coupling member 200. For example, the supporting member 300 may be connected to or coupled to the edge portion of the second surface 500b of the vibration apparatus 500 via the coupling member 200. For example, the second supporting part 330 may be connected to or coupled to the vibration apparatus 500 via the coupling member 200. For example, the second supporting part 330 may be connected to or coupled to the second surface 500b of the vibration apparatus 500 via the coupling member 200. For example, the second supporting part 330 may be connected to or coupled to the edge portion of the second surface 500b of the vibration apparatus 500 via the coupling member 200.

The coupling member 200 may be configured to minimize, reduce, or prevent vibration of the vibration apparatus 500 from being transmitted to the supporting member 300.

The coupling member 200 according to one aspect of the present disclosure prevents or reduces physical contact (or friction) between the vibration apparatus 500 and the second supporting part 330 of the supporting member 300, thereby preventing or reducing noise caused by the physical contact (or friction) between the vibration member 100 and the supporting member 300.

FIG. 20 illustrates sound output characteristics of the apparatus illustrated in FIG. 19 according to another aspect of the present disclosure. FIG. 20 illustrates sound output characteristics of the apparatus according to another aspect of the present disclosure described with reference to FIG. 19. In FIG. 20, a horizontal axis represents a frequency (Hz), and a vertical axis represents a sound pressure level SPL (dB).

The following Table 10 shows the average sound pressure level SPL (dB) characteristic for each frequency (Hz) according to another aspect of the present disclosure. The inventor of the present disclosure prepares samples of aspects 2 and 3 to confirm the average sound pressure level SPL (dB) characteristic for each frequency (Hz) according to another aspect of the present disclosure. In Table 10, the aspect 2 is prepared in the same manner as the aspect 2 of FIG. 14 and Table 4. The aspect 3 is prepared according to another aspect of the present disclosure described with reference to FIG. 19. In the aspect 3, aluminum is used for the inner member and epoxy is used for the outer member. In the aspect 3, a thickness of the inner member is 0.3 mm and a thickness of the outer member is 0.1 mm. A thickness of the vibration apparatus is 0.165 mm, and a thickness of the vibration member is 0.45 mm. The horizontal and vertical lengths of the vibration apparatus and the vibration member are configured to be 60 cm and 120 cm, respectively, and an area ratio of the vibration apparatus and the vibration member is 1.0. FIG. 20 shows the average sound pressure level SPL (dB) characteristic for each frequency (Hz) of the aspect 3.

TABLE 10

| | | |
|---|---|---|
| Frequency (Hz) | 0.15~20k | 0.15~8k |

| | | | |
|---|---|---|---|
| Average Sound Pressure | Aspect 2 | 78.09 | 76.31 |
| Level SPL (dB) | Aspect 3 | 74.09 | 70.76 |

Referring to FIG. 20 and Table 10, the average sound pressure level SPL (dB) for each frequency (Hz) of aspect 3 is measured as 74.09 dB at 0.15 kHz to 20 kHz, and 70.76 dB at 0.15 kHz to 8 kHz, and it is confirmed that the average sound pressure level SPL (dB) characteristic of the aspect 3 has the lower sound pressure characteristic as compared to that of the aspect 2. Accordingly, it may be confirmed that the sound pressure characteristic is more improved in the configuration in which the area of the vibration apparatus 500 is smaller than that of the vibration member 100, and the vibration apparatus 500 is surrounded by the supporting member 300, as compared to the configuration in which the area of the vibration apparatus 500 is the same as the area of the vibration member 100.

An apparatus according to one or more example aspects of the present disclosure are described below.

An apparatus according to one or more aspects of the present disclosure may include a vibration member, and a vibration apparatus configured to vibrate the vibration member. The vibration member may include an inner member and an outer member surrounding the inner member.

According to one or more aspects of the present disclosure, the outer member may cover all surfaces of the inner member.

According to one or more aspects of the present disclosure, the inner member may be embedded inside the outer member.

According to one or more aspects of the present disclosure, the inner member and the outer member may be different materials.

According to one or more aspects of the present disclosure, the inner member may be a metal material.

According to one or more aspects of the present disclosure, the outer member may be a plastic material.

According to one or more aspects of the present disclosure, the inner member may be an aluminum material, and the outer member may be an epoxy material.

According to one or more aspects of the present disclosure, the inner member and the outer member may differ from each other in at least one or more of a stiffness, a density, and a Young's modulus.

According to one or more aspects of the present disclosure, the density of the inner member may be in a range of 1.7 g/cm³ to 2.8 g/cm³.

According to one or more aspects of the present disclosure, the modulus of the inner member may be in a range of 1 GPa to 100 GPa.

According to one or more aspects of the present disclosure, the density of the outer member may be in a range of 1.2 g/cm³ to 1.4 g/cm³.

According to one or more aspects of the present disclosure, the modulus of the outer member may be in a range of 2 GPa to 10 GPa.

According to one or more aspects of the present disclosure, the thickness of the inner member may be greater than the thickness of the outer member, in a region where the inner member and the outer member overlap vertically.

According to one or more aspects of the present disclosure, the outer member may comprise a first outer member on a first surface of the inner member, and a second outer member on a second surface of the inner member opposite to the first surface of the inner member.

According to one or more aspects of the present disclosure, the first outer member may accommodate the entire first surface of the inner member and a first portion of a side surface of the inner member, and the second outer member accommodates the entire second surface of the inner member and a second portion of a side surface of the inner member.

According to one or more aspects of the present disclosure, the first outer member and the second outer member may be a same material.

According to one or more aspects of the present disclosure, the first outer member and the second outer member may have a same thickness.

According to one or more aspects of the present disclosure, the vibration apparatus may comprise a vibration part including a piezoelectric material, and a cover member covering at least one of a first surface of the vibration part and a second surface of the vibration part opposite to the first surface of the vibration part.

According to one or more aspects of the present disclosure, the vibration apparatus may further include a signal supply member electrically connected to the vibration part, and a portion of the signal supply member is accommodated between the cover member and the vibration part.

According to one or more aspects of the present disclosure, the signal supply member and the vibration part may be integrated as one body.

According to one or more aspects of the present disclosure, the vibration apparatus may comprise a first vibration generating part, a second vibration generating part stacked on the first vibration generating part, and an intermediate member between the first vibration generating part and the second vibration generating part. One of the first vibration generating part and the second vibration generating part may be connected to the vibration member.

According to one or more aspects of the present disclosure, each of the first and second vibration generating parts may include a vibration part including a piezoelectric material, and a cover member covering at least one or more of a first surface of the vibration part and a second surface opposite to the first surface of the vibration part.

According to one or more aspects of the present disclosure, the apparatus may further comprise a supporting member at a rear surface of the vibration member and including an internal space surrounding the rear surface of the vibration member and a coupling member through which the supporting member is coupled to the vibration member.

According to one or more aspects of the present disclosure, the coupling member may include a first coupling member and a second coupling member between the vibration member and the supporting member. The first coupling member may be disposed inward from the second coupling member.

According to one or more aspects of the present disclosure, the first coupling member may have a hardness larger than that of the second coupling member.

According to one or more aspects of the present disclosure, the first coupling member may have a hardness smaller than that of the second coupling member.

According to one or more aspects of the present disclosure, an area of the vibration apparatus may be smaller than that of the vibration member.

According to one or more aspects of the present disclosure, an area ratio of the vibration apparatus and the vibration member may be in a range of 0.08 to 0.12.

An apparatus according to one or more aspects of the present disclosure may include a vibration plate, a piezoelectric layer disposed on the vibration plate, and a signal supply line electrically connected between the piezoelectric layer and the vibration plate, the piezoelectric layer configured to vibrate the vibration plate via a signal provided by the signal supply line. The vibration plate may include an inner member and an outer member surrounding the inner member.

According to one or more aspects of the present disclosure, the piezoelectric layer may include a first piezoelectric layer and a second piezoelectric layer. The apparatus may further include an intermediate layer between the first piezoelectric layer and the second piezoelectric layer.

According to one or more aspects of the present disclosure, one of the first piezoelectric layer and the second piezoelectric layer may be connected to the vibration plate.

It will be apparent to those skilled in the art that various modifications and variations can be made in the present disclosure without departing from the scope of the disclosures. Thus, it is intended that the present disclosure covers the modifications and variations of this disclosure and their equivalents. The scope of the claims is not limited by the disclosure.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus, comprising:
a vibration member; and
a vibration apparatus configured to vibrate the vibration member,
wherein the vibration member includes an inner member and an outer member surrounding the inner member.

2. The apparatus of claim 1, wherein the outer member covers all surfaces of the inner member.

3. The apparatus of claim 1, wherein the inner member is embedded inside the outer member.

4. The apparatus of claim 1, wherein the inner member and the outer member are different materials.

5. The apparatus of claim 4, wherein the inner member is a metal material, and the outer member is a plastic material.

6. The apparatus of claim 4, wherein the inner member is an aluminum material, and the outer member is an epoxy material.

7. The apparatus of claim 1, wherein the inner member and the outer member differ from each other in at least one of a stiffness, a density, and a Young's modulus.

8. The apparatus of claim 7, wherein the density of the inner member is in a range of 1.7 g/cm³ to 2.8 g/cm³, or
wherein the modulus of the inner member is in a range of 1 GPa to 100 GPa, or
wherein the density of the outer member is in a range of 1.2 g/cm³ to 1.4 g/cm³, or
wherein the modulus of the outer member is in a range of 2 GPa to 10 GPa.

9. The apparatus of claim 1, wherein a thickness of the inner member is greater than a thickness of the outer member in a region where the inner member and the outer member overlap vertically.

10. The apparatus of claim 1, wherein the outer member comprises:
a first outer member at a first surface of the inner member; and
a second outer member at a second surface of the inner member opposite to the first surface of the inner member.

11. The apparatus of claim 10, wherein the first outer member accommodates the entire first surface of the inner member and a first portion of a side surface of the inner member, and
wherein the second outer member accommodates the entire second surface of the inner member and a second portion of a side surface of the inner member.

12. The apparatus of claim 10, wherein the first outer member and the second outer member are a same material.

13. The apparatus of claim 10, wherein the first outer member and the second outer member have a same thickness.

14. The apparatus of claim 1, wherein the vibration apparatus comprises:
a vibration part including a piezoelectric material; and
a cover member covering at least one of a first surface of the vibration part and a second surface of the vibration part opposite to the first surface of the vibration part.

15. The apparatus of claim 14, wherein the vibration apparatus further includes a signal supply member electrically connected to the vibration part, and
wherein a portion of the signal supply member is accommodated between the cover member and the vibration part.

16. The apparatus of claim 1, wherein the vibration apparatus comprises:
a first vibration generating part;
a second vibration generating part stacked on the first vibration generating part; and
an intermediate member between the first vibration generating part and the second vibration generating part, and
wherein one of the first vibration generating part and the second vibration generating part is connected to the vibration member.

17. The apparatus of claim 16, wherein each of the first and second vibration generating parts includes:
a vibration part including a piezoelectric material; and
a cover member covering at least one of a first surface of the vibration part and a second surface of the vibration part opposite to the first surface of the vibration part.

18. An apparatus, comprising:
a vibration plate;
a piezoelectric layer disposed on the vibration plate; and
a signal supply line electrically connected between the piezoelectric layer and the vibration plate, the piezoelectric layer configured to vibrate the vibration plate via a signal provided by the signal supply line,
wherein the vibration plate includes an inner member and an outer member surrounding the inner member.

19. The apparatus of claim 18, wherein the piezoelectric layer includes a first piezoelectric layer and a second piezoelectric layer, the apparatus further comprising:
an intermediate layer between the first piezoelectric layer and the second piezoelectric layer.

20. The apparatus of claim 19, wherein one of the first piezoelectric layer and the second piezoelectric layer is connected to the vibration plate.
